(19) United States
(12) Patent Application Publication
(10) Pub. No.: US 2026/0310696 A1
(43) Pub. Date: Oct. 8, 2026

(54) METHOD AND SYSTEM FOR GENERATING ANSWERS BASED ON INFORMATION RETRIEVAL

(71) Applicant: LG MANAGEMENT DEVELOPMENT INSTITUTE CO., LTD., Seoul (KR)

(72) Inventors: Hae Ju PARK, Seoul (KR); Kyung Jae Lee, Seoul (KR); Sung Hyun Park, Seoul (KR); Moon Tae Lee, Goyang-si (KR)

(21) Appl. No.: 19/460,210

(22) Filed: Jan. 26, 2026

Related U.S. Application Data
(63) Continuation of application No. PCT/KR2025/008838, filed on Jun. 24, 2025.

(30) Foreign Application Priority Data
Jun. 25, 2024 (KR) 10-2024-0082994
May 19, 2025 (KR) 10-2025-0064550
Jun. 23, 2025 (KR) 10-2025-0082908

(51) Int. Cl. G06F 16/3329; G06F 16/334

(52) U.S. Cl. CPC G06F 16/33295; G06F 16/3344; G06F 16/3347

(57) ABSTRACT

The present disclosure relates to a method and system for generating answers based on information retrieval, the method and system being capable of retrieving external knowledge and generating answers to user queries. In an embodiment, a computerized method for generating answers based on information retrieval comprises receiving a user query from a user terminal, specifying a plurality of candidate documents associated with the user query based on preset criteria, each candidate document including at least one passage, determining relevance to the user query on a passage-by-passage basis for each passage included in the plurality of candidate documents, specifying a relevant document that is associated with the user query among the plurality of candidate documents based on the relevance to the user query determined for each passage included in the plurality of candidate documents, and generating an answer to the user query using the relevant document.

### CROSS REFERENCE TO RELATED APPLICATIONS

This application is a Bypass Continuation of International Patent Application No. PCT/KR2025/008838, filed on Jun. 24, 2025, which claims priority from and the benefit of Korean Patent Application No. 10-2024-0082994, filed on Jun. 25, 2024, Korean Patent Application No. 10-2025-0064550, filed on May 19, 2025, and Korean Patent Application No. 10-2025-0082908, filed on Jun. 23, 2025, each of which is hereby incorporated by reference for all purposes as if fully set forth herein.

### BACKGROUND

### Field

Embodiments of the invention relate generally to a method and system for generating answers based on information retrieval. More particularly, the present disclosure relates to a computer method and system for generating answers that is capable of retrieving external knowledge and and processing the external knowledge to generate answers to user queries.

### DISCUSSION OF THE BACKGROUND

The dictionary definition of artificial intelligence may be a technology that realizes human learning ability, inference ability, perception ability, natural language understanding ability, etc., using computer programs. Such artificial intelligence computer technology has achieved remarkable progress due to deep learning.

In particular, thanks to the advancement of artificial intelligence, various language models have been developed. The language models have reached a level of sophistication at which they not only recognize text and understand its meaning, but they also extract information from vast amounts of text data, such as documents, classify the extracted information, and even generate text directly.

The language models are actively utilized in various fields, where their automated application to text accomplishes tasks previously achievable only by human effort, such as searches performed by search engines, document writing (e.g., resume writing, report writing, post writing, etc.), free conversation on diverse topics, data parsing (e.g., data summarization, classification, etc.) from given texts, expert knowledge extraction from diverse sources, programming, and transforming given sentences into an appropriate style for a desired purpose.

In this regard, recently, large language models (LLMs) that understand and generate human language through pre-training on vast amounts of text data have emerged. Unlike the existing chatbot, which is manually constructed and thus provides only limited answers, the large language models (LLMs) demonstrate technological capability that enables communication as naturally as it would occur with a human researcher, provide information quickly and accurately and demonstrate innovation in the artificial intelligence market.

However, because the large language models rely solely on knowledge included in a finite set of parameters, the large language models tend to generate inaccurate or outdated information, especially in domain-specific tasks.

To overcome these limitations, a retrieval augmented generation (RAG) technique, which incorporates external knowledge, is attracting attention as a promising approach. The retrieval augmented generation (RAG) technique may improve upon the accuracy of content generated by the large language models without retraining. However, effectively retrieving external knowledge still remains challenging with RAG techniques, due to potential noise, computational costs, etc.

To address these concerns, the conventional information retrieval system utilizes a two-step approach including 1) quickly retrieving a small number of candidate documents from a large number of documents using an efficient retriever, and 2) applying a reranking mechanism to candidate documents using a sophisticated reranker.

However, the conventional information retrieval system (or model) may only perform a single-granularity ranking at a time and have a limited context size, and, therefore, have difficulties being directly applied to real-world RAG situations in an effective and efficient way.

The above information disclosed in this Background section is only for understanding of the background of the inventive concepts, and, therefore, it may contain information that does not constitute prior art.

### SUMMARY

The present disclosure is directed to providing a method and system for generating answers based on information retrieval, the method and system being capable of simultaneously improving retrieval efficiency and the accuracy of content generation in comparison to previously known methods and systems.

More specifically, the present disclosure is directed to providing a method and system for generating answers based on information retrieval, the method and system being capable of simultaneously improving retrieval efficiency and the accuracy of content generation by simultaneously performing the document reranking and passage extraction necessary for content generation.

In particular, the present disclosure is directed to providing a method and system for generating answers based on information retrieval, where the method and system are capable of simultaneously determining the relevance of passages to documents.

In addition, the present disclosure is directed to providing a method and system for generating answers based on information retrieval, where the method and system are capable of simultaneously retrieving documents associated with queries and extracting passages associated with the queries from the retrieved documents.

In addition, the present disclosure is directed to providing a method and system for generating answers based on information retrieval, where the method and system are capable of generating and providing more accurate and relevant answers to queries by efficiently retrieving documents and passages associated with the queries.

In addition, the present disclosure provides a method and system for generating answers based on information retrieval, where the method and system are capable of providing a user-customized environment.

More specifically, the present disclosure provides a method and system for generating answers based on information retrieval, where the method and system are capable of providing a service environment optimized for a user while providing accurate, high-quality answers to user queries.

Furthermore, the present disclosure is directed to providing a method and system for generating answers based on information retrieval, where the method and system are capable of providing customized information to a user and enabling the user to efficiently search for accurate information.

Additional features of the inventive concepts will be set forth in the description which follows, and in part will be apparent from the description, or may be learned by practice of the inventive concepts.

To solve the problems described above, according to an aspect of the present disclosure, a computerized method for generating answers based on information retrieval can include receiving a user query from a user terminal, specifying a plurality of candidate documents associated with the user query based on presetcriteria, each candidate document including at least one passage, determining relevance to the user query on a passage-by-passage basis, wherein each passage is included in at least one of the plurality of candidate documents, specifying a relevant document that is associated with the user query among the plurality of candidate documents based on the relevance to the user query determined for each passage included in the plurality of candidate documents, and generating an answer to the user query using the relevant document.

In some embodiments, the computerized method can further comprise configuring input data such that the user query and a specific passage among the passages included in the plurality of candidate documents form a pair; and processing the input data as input to an encoder to specify the relevant document associated with the user query among the plurality of candidate documents, wherein the determining of the relevance to the user query can include determining the relevance to the user query for each passage included in the plurality of candidate documents using an embedding vector corresponding to the input data acquired from the encoder.

In some embodiments, when the specific passages are plural, the input data can include a plurality of specific passages.

In some embodiments, the encoder can perform an interaction between the user query and the specific passages included in the input data to acquire the embedding vector corresponding to the input data.

In some embodiments, when the input data includes the plurality of specific passages, the plurality of embedding vectors corresponding to the input data can be acquired from the encoder.

In some embodiments, wherein the input data includes the plurality of specific passages, the determining of the relevance to the user query can include: combining the plurality of embedding vectors into one to generate a combined embedding vector; processing the combined embedding vector as input to a decoder; and determining a relevance to the user query for each of the plurality of candidate documents using the combined embedding vector in the decoder.

In some embodiments, the combined embedding vector can represent overall semantic relevance between the user query and passages included in the plurality of candidate documents.

In some embodiments, the decoder can generate a relevance word token for each of the plurality of candidate documents based on the relevance determined using the combined embedding vector.

In some embodiments, the relevance word token can display a word token state representing whether the user query and the corresponding document have relevance to each other, and can be configured to include a first relevance word token if the user query and the corresponding document are relevant to each other or a second relevance word token if the user query and the corresponding document are not relevant to each other.

In some embodiments, the decoder can be configured to predict the relevance word token state for each of the plurality of candidate documents.

In some embodiments, a document including the first relevance word token among the plurality of candidate documents can be specified as the relevant document associated with the user query.

In some embodiments, when the input data includes the plurality of specific passages, the plurality of embedding vectors corresponding to the input data can be acquired from the encoder, and the determining of the relevance to the user query can include processing the plurality of embedding vectors as input to a ranker layer and determining the relevance to the user query for each passage included in the plurality of candidate documents using the plurality of embedding vectors in the ranker layer.

In some embodiments, the ranker layer can generate a passage relevance score for each passage included in the plurality of candidate documents based on the relevance determined using the plurality of embedding vectors.

In some embodiments, the passage relevance score can be a score representing whether there is relevance between each of the plurality of passages and the user query and can be configured to include a first score if the passage and user query are relevant to each other or a second score if the passage and user query are not relevant to each other.

In some embodiments, the ranker layer can be trained to predict a relative similarity between passages included in the plurality of candidate documents using an inter-passage attention mechanism for the plurality of embedding vectors.

In some embodiments, the specifying of the relevant document can further include specifying a relevant passage associated with the user query among the passages included in the plurality of candidate documents to generate an answer to the user query.

In some embodiments, wherein the preset criteria are used in the specifying of the relevant passage, the passage that satisfies the preset criteria among the passages included in the plurality of candidate documents can be specified as the relevant passage, and the relevant passage can correspond to a passage included in the relevant document associated with the user query.

In some embodiments, in the generating of the answer, the answer to the user query can be generated using at least one of the relevant document and the relevant passage, and information on the relevant document is displayed on the user terminal such that the relevant document used to generate the answer can be confirmed by the user.

In some embodiments, the computerized method for generating answers can further comprise providing the answer generated for the user query to a service page, wherein the service page further includes at least one recommended query associated with the relevant document.

In some embodiments, in the computerized method for generating answers, the step of determining relevance to the user query for each passage included in the plurality of candidate documents can be performed by using parallel processing to compare the user query with a plurality of the passages simultaneously.

According to another aspect of the present disclosure, a system for generating answers based on information retrieval can comprise a memory configured to store executable instructions and one or more processors configured to perform an operation by executing one or more instructions, wherein the system for generating answers based on information retrieval can receive a user query from a user terminal, can specify a plurality of candidate documents associated with the user query based on presetcriteria, can determine relevance to the user query for each passage included in the plurality of candidate documents, can specify a relevant document associated with the user query among the plurality of candidate documents based on the relevance to the user query determined for each passage included in the plurality of candidate documents, and can generate an answer to the user query using the relevant document.

According to another aspect of the present disclosure, a computerized method for generating answers based on information retrieval can comprise receiving a user query from a user terminal, specifying a plurality of candidate documents associated with the user query based on preset criteria, each candidate document including at least one passage, ranking simultaneously a relevance to the user query for each passage included in the plurality of candidate documents and a relevance to the user query for each of the plurality of candidate documents, specifying a most relevant document that is associated with the user query among the plurality of candidate documents based on both of the relevance to the user query determined for each passage included in the plurality of candidate documents and the relevance to the user query determined for each candidate document, and generating an answer to the user query using the most relevant document.

According to another aspect of the present disclosure, a computerized method for generating answers based on information retrieval can comprise receiving a user query from a user terminal, specifying a plurality of candidate documents associated with the user query based on presetcriteria, specifying a relevant document that is associated with and most relevant to the user query among the plurality of candidate documents based on the relevance to the user query determined for each passage included in each of the plurality of candidate documents, generating an answer to the user query using the relevant document, and providing the answer to the user terminal along with information on the relevant document used to generate the answer.

In some embodiments, in the providing of the answer to the user terminal along with the information on the relevant document used to generate the answer, the relevant document associated with the user query among the plurality of candidate documents is specified based on user's history information, and information on the answer generated using the specified relevant document and on the relevant document used to generate the answer may be provided.

In some embodiments, in the generating of the answer, a relevant passage associated with the user query and to be used to generate the answer may be specified among the passages included in the plurality of candidate documents and the answer may be generated using at least one of the relevant document and the relevant passage.

In some embodiments, in the providing of the answer along with the information on the relevant document, the information on the relevant document may be displayed on the user terminal to enable the identification of the relevant document used to generate the answer.

In some embodiments, the information on the relevant document may include at least one of the relevant passage, a name of the relevant document, and a storage location of the relevant document.

In some embodiments, a pre-specified storage may store at least one of the user query, the answer to the user query, the relevant document associated with the user query, and the information on the relevant document.

In some embodiments, the computerized method may further include providing at least one recommended query to the user terminal based on preset query recommendation criteria.

In some embodiments, in the providing of the at least one recommended query, the relevant document associated with each of the at least one recommended query may be provided to the user terminal along with the at least one recommended query and each of the at least one recommended query may be displayed on the user terminal in respectively different visual appearances.

In some embodiments, the at least one recommended query may include at least one of a first recommended query having a first visual appearance and a second recommended query having a second visual appearance different from the first visual appearance among the respectively different visual appearances, and the relevant document associated with each of the at least one recommended query may include at least one of a first relevant document associated with the first recommended query and a second relevant document associated with the second recommended query.

In some embodiments, the relevant document associated with each of the at least one recommended query may be displayed on the user terminal in the same visual appearance as the visual appearance included in each of the at least one recommended query to enable the identification of the relevance to each of the at least one recommended query, the first recommended query and the first relevant document associated with the first recommended query may be displayed on the user terminal in the first visual appearance, and the second recommended query and the second relevant document associated with the second recommended query may be displayed on the user terminal in the second visual appearance.

In some embodiments, when a specific recommended query of any one of the at least one recommended query is selected from the user terminal, the user terminal may be provided with an answer to the specific recommended query, along with information on a specific relevant document used to generate an answer to the selected specific recommended query, among the relevant documents associated with the specific recommended query.

In some embodiments, the information on the specific relevant document may be highlighted on the user terminal to enable identification of the specific relevant document used to generate the answer to the specific recommended query.

In some embodiments, the information among the passages included in the specific relevant document is associated with the specific recommended query, and may include at least one of a specific relevant passage used to generate the answer to the specific recommended query, a name of the specific relevant document, and a storage location of the specific relevant document.

In some embodiments, the computerized method may further include providing a plurality of recommended documents to the user terminal based on preset document recommendation criteria.

In some embodiments, in the providing of the plurality of recommended documents, the user terminal may be provided with at least one of chat history information associated with each of the plurality of recommended documents and information on each of the plurality of recommended documents.

In some embodiments, the chat history information may include at least one of a user query associated with each of the plurality of recommended documents and an answer generated using each of the plurality of recommended documents.

According to another aspect of the present disclosure, a system including a memory configured to store executable instructions and one or more processors configured to perform an operation by executing one or more instructions, in which the system may receive a user query from a user terminal, specify a plurality of candidate documents associated with the user query based on preset criteria, specify a relevant document associated with the user query among the plurality of candidate documents based on the relevance to the user query determined for each passage included in each of the plurality of candidate documents, generate an answer to the user query using the relevant document, and provide the answer to the user terminal along with information on the relevant document used to generate the answer.

A program according to the present disclosure can be a program storable on a computer-readable medium, executed by one or more processes in an electronic device, in which the program may include instructions to perform receiving a user query from a user terminal, specifying a plurality of candidate documents associated with the user query based on preset criterion, specifying a relevant document associated with the user query among the plurality of candidate documents based on the relevance to the user query determined for each passage included in each of the plurality of candidate documents, generating an answer to the user query using the relevant document, and providing the answer to the user terminal along with information on the relevant document used to generate the answer.

According to the method and system for generating answers based on information retrieval according to the present disclosure as described above, by constructing input data as pairs of queries and passages included in candidate documents and independently encoding the input data to generate semantic representations, it is possible to process a large quantity of input documents in parallel. That is, according to the present disclosure, by encoding the plurality of passages within the input documents in parallel without separate sequential processing, it is possible to optimize the semantic representations by considering those generated for each passage, increase the input processing speed of the system, and ensure real-time responsiveness to large data sets.

In addition, according to the method and system for generating answers based on information retrieval according to the present disclosure, by integrating the encoded semantic representations and predicting the relevance between the query and the entire document through the relevance word token using the integrated semantic representations, it is possible to accurately determine the relevance of the entire document. Through this, according to the present disclosure, it is possible to perform accurate, document-level ranking that reflects the integrated meaning of the plurality of passages and to improve the document retrieval performance compared to conventional information retrieval systems.

Furthermore, according to the method and system for generating answers based on information retrieval according to the present disclosure, by applying the inter-passage attention mechanism to the encoded semantic expressions to train the relative similarity between the passages, it is possible to distinguish the semantic differences between the plurality of passages and improve the accuracy and consistency of the passage-level ranking.

In addition, according to the method and system for generating answers based on information retrieval according to the present disclosure, by training the model to simultaneously perform the document reranking and the passage extraction necessary for the answer generation, it is possible to ensure the balanced quality between the document ranking and the passage ranking. Through this, it is possible to achieve the highly reliable ranking results at both the document level and the passage level, and maintain the consistent performance in various retrieval and response generation systems.

Furthermore, according to the method and system for generating answers based on information retrieval according to the present disclosure, it is possible to train the model to simultaneously determine the relevance between the query and the entire document and the relevance between the query and each of the plurality of passages in the document. In other words, according to the present disclosure, by simultaneously optimizing and ranking the documents and the passages, it is possible to reduce the influence of noisy context in the externally retrieved information and improve the accuracy and reliability of the LLM responses generated based on this. It is possible to enable quick and stable retrieval and response processing even in the real-time RAG system environment where large information retrieval occurs, prevent errors that may occur in the LLM responses, and enhance user reliability.

In addition, according to the method and system for generating answers based on information retrieval according to the present disclosure, it is possible to reduce unnecessary computation and optimize computational resource usage through a multi-granularity ranking structure via a single inference path. Through this, it is possible to reduce server infrastructure costs and improve the operational efficiency of a large AI search system.

In addition, according to the method and system for generating answers based on information retrieval according to the present disclosure, by providing information on the relevant documents associated with the user query along with answers generated using those relevant documents, it is possible to cause users to intuitively recognize and more quickly understand the information they need.

Furthermore, according to the method and system for generating answers based on information retrieval according to the present disclosure, by visually providing the information on the documents utilized in the answer generation process, it is possible to cause users to intuitively confirm the source and reliability of the answer, quickly and accurately obtain the information they need, and maximize the efficiency of the search of the relevant documents.

In addition, according to the method and system for generating answers based on information retrieval according to the present disclosure, it is possible to select relevant documents associated with user queries based on user history information and provide answers to user queries based on the selected documents. In other words, according to the present disclosure, by providing the customized information to the users by reflecting their preferences, interests, LLM usage patterns and the like, it is possible to significantly improve the personalized performance of the answer generation service as well as the quality of interaction with the users.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the inventive concepts.

FIG. 1 is a conceptual diagram for describing a system for generating answers based on information retrieval according to the present disclosure.

FIG. 2 is a flowchart for describing a method for generating answers based on information retrieval according to the present disclosure.

FIG. 3A is a conceptual diagram for describing a method for training an information retrieval model according to an embodiment of the present disclosure.

FIG. 3B is a conceptual diagram for describing a method for training an information retrieval model according to another embodiment of the present disclosure.

FIG. 4 is a conceptual diagram for describing a method for generating answers based on information retrieval according to an embodiment of the present disclosure.

FIG. 5 is a conceptual diagram for describing a method for generating answers based on information retrieval according to another embodiment of the present disclosure.

FIG. 6 is a conceptual diagram for describing a method for generating answers based on information retrieval according to another embodiment of the present disclosure.

FIG. 7A is a conceptual diagram for describing a method for generating answers based on information retrieval according to another embodiment of the present disclosure.

FIG. 7B is a conceptual diagram for describing a method for generating answers based on information retrieval according to another embodiment of the present disclosure.

FIG. 8 shows mathematical formulas related to methods for generating answers based on information retrieval according to embodiments of the present disclosure.

FIG. 9 shows mathematical formulas related to methods for generating answers based on information retrieval according to embodiments of the present disclosure.

FIG. 10 shows tables illustrating a) learning results of an information retrieval model trained using a learning method according to an embodiment of the present disclosure and b) learning results comparing that model with conventional information retrieval models.

FIG. 11 shows graphs illustrating that the information retrieval model 160 (e.g., “PFiD”) trained using the learning method described in the present disclosure maintains superior ranking performance compared to conventional information retrieval techniques, even under various document and passage count conditions. The plots show normalized discounted cumulative gain versus the number of passages for different numbers of considered documents. nDCG@10 is a metric that assesses ranking quality of retrieved documents. On a scale of zero to one, higher nDCG@10 numbers indicate that relevant documents appear earlier in the ranking list.

FIG. 12 shows graphs illustrating that information retrieval model 160 (e.g., “PFiD”) trained using the learning method described in the present disclosure more intensively arranges relevant passages at higher ranks in comparison with a conventional “cross attention” information retrieval model. The data indicate that the information retrieval model 160 (e.g., “PFiD”) trained using the learning method described in embodiments of the present disclosure enables more accurate relevance determination than does the conventional model.

FIG. 13 is a flowchart for describing the method for generating answers based on information retrieval according to embodiments of the present disclosure.

FIG. 14A illustrates a service page with constituent areas for providing different kinds of information to a user via a user terminal according to an embodiment of the present disclosure.

FIG. 14B illustrates a service page with constituent areas for providing different kinds of information to a user via a user terminal according to an embodiment of the present disclosure, showing that identification of a language model, a file list and relevant passages can be shown in different areas of the service page.

FIG. 15A illustrates a service page with constituent areas for providing different kinds of information to a user via a user terminal according to an embodiment of the present disclosure, showing that the the different kinds of information can include a query list and an associated file list.

FIG. 15B illustrates a service page with constituent areas for providing different kinds of information to a user via a user terminal according to an embodiment of the present disclosure, showing that the different kinds of informatino can include recommended queries and answers as well as submitted queries, a file list and relevant passages from reference documents.

FIG. 16A illustrates a service page with constituent areas for providing different kinds of information to a user via a user terminal according to an embodiment of the present disclosure, showing that a provided query can be keyword specific.

FIG. 16B illustrates a service page with constituent areas for providing different kinds of information to a user via a user terminal according to an embodiment of the present disclosure, showing that a provided answer can be tailored by selection of a graphic object corresponding to a particular suggested query.

FIG. 17 illustrates a service page with constituent areas for providing different kinds of information to a user via a user terminal according to an embodiment of the present disclosure, showing that the system of the present disclosure can provide a plurality of recommended documents in one of the constituent areas of the service page.

### DETAILED DESCRIPTION

The presently described methods and systems address a need in the art for more efficient generation of answers to user queries through more efficient and thorough automated retrieval and analysis of documents that may be derived from large collections of information.

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods employing one or more of the inventive concepts disclosed herein. It is apparent, however, that various embodiments may be practiced without these specific details or with one or more equivalent arrangements. In other instances, well-known structures and devices are shown in block diagram form in order to avoid unnecessarily obscuring various embodiments. Further, various embodiments may be different, but do not have to be exclusive. For example, specific shapes, configurations, and characteristics of an embodiment may be used or implemented in another embodiment without departing from the inventive concepts.

Unless otherwise specified, the illustrated embodiments are to be understood as providing features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z – axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various embodiments are described herein with reference to sectional and/or exploded illustrations that are schematic illustrations of idealized embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the inventive concepts. Further, the blocks, units, and/or modules of some embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

Hereafter, embodiments disclosed in the present specification will be described in detail with reference to the accompanying drawings and the same or similar components are given the same reference numerals regardless of the numbers of figures and are not repeatedly described. In addition, terms “module” and “unit” for components used in the following description are used only to easily make the disclosure. Therefore, these terms do not have meanings or roles that distinguish from each other in themselves. Further, when it is determined that a detailed description for the related known art in describing embodiments disclosed in the present specification may obscure the gist of the present disclosure, a detailed description thereof will be omitted. Further, it should be understood that the accompanying drawings are provided only in order to allow embodiments disclosed in the present specification to be easily understood, and the spirit of the present disclosure is not limited by the accompanying drawings, but includes all the modifications, equivalents, and substitutions included in the spirit and the scope of the present disclosure.

Terms including ordinal numbers such as “first”, “second”, etc., may be used to describe various components, but the components are not to be construed as being limited to the terms. The terms are used to distinguish one component from another component.

The present disclosure relates to a method and system for generating answers based on information retrieval. The system for generating answers based on information retrieval according to the present disclosure generates an answer based on generative artificial intelligence (generative AI) or a foundation model, and may also be referred to as an answer generation platform based on an ultra-large foundation model. However, the "ultra-large foundation model" may also be referred to as a generative model, a foundation model, or a large language model (LLM).

The present disclosure may be a system that more efficiently improves a retrieval augmented generation (RAG) system that integrates external knowledge to provide appropriate answers to user queries.

In an embodiment, the conventional RAG system may be composed of a document retriever, a reranker module, and a decoder for generating a final response. When a user query is input, the conventional RAG system utilizes the document retriever to retrieve top N candidate documents associated with the query from a large document corpus (or a large knowledge base). For example, the document retriever may include a BM25 or a dense retriever. The reranker may perform independent model inference in each component to rank candidate documents and passages, and may additionally extract and arrange passages with high relevance within the reranked documents. The decoder may input the reranked (or selected) documents or the passages to an answer generation model, and generate a final answer (or response) through the answer generation model.

In this way, the conventional RAG system requires independent model inference in each component to rank the documents and passages, but the present disclosure may utilize a passage fusion-in-decoder (PFiD) structure to propose an information retrieval model (or retrieval model, document retrieval model, etc.) that may simultaneously rank the documents and passages with a single inference.

The system for generating answers based on information retrieval according to the present disclosure may be a system that efficiently retrieves (or extracts) documents and passages associated with a query and generates and provides a more accurate and relevant answer to the query. To this end, the system for generating answers based on information retrieval according to the present disclosure includes an information retrieval model (or retrieval model, document retrieval model, etc.) that simultaneously retrieves for the document associated with the query and extracts the passage associated with the query from the retrieved document. The present disclosure aims to simultaneously improve retrieval efficiency and content generation accuracy.

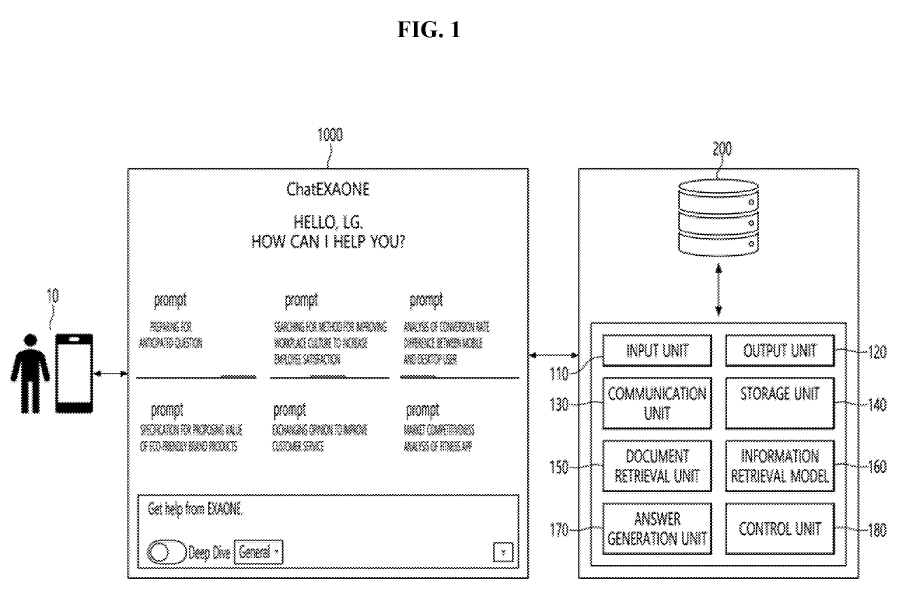

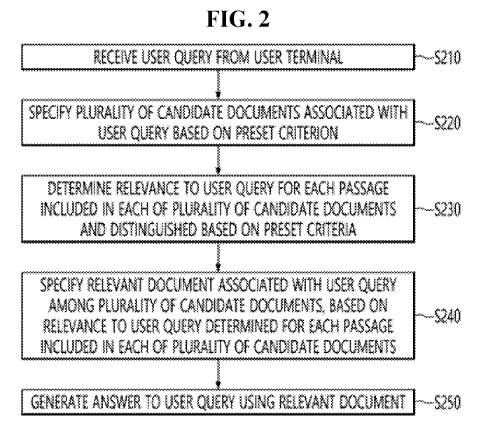

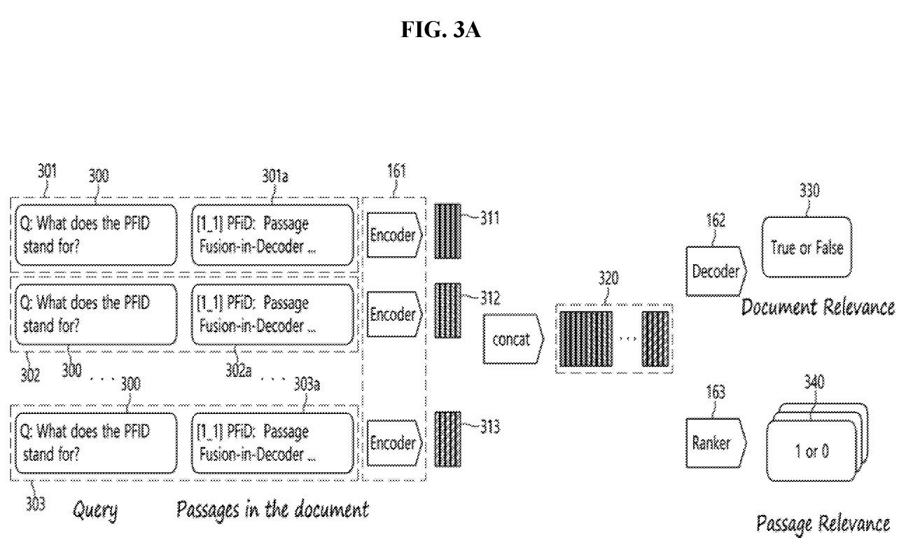

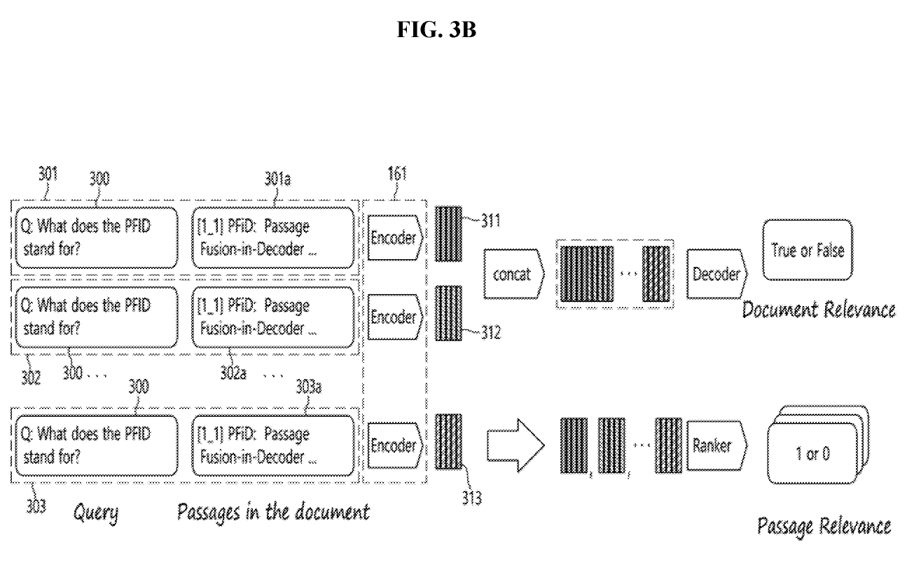

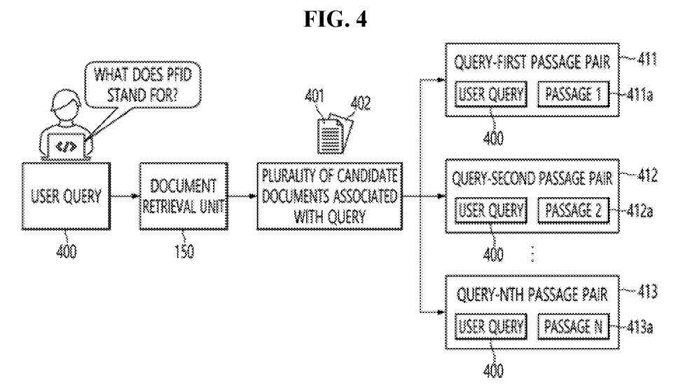

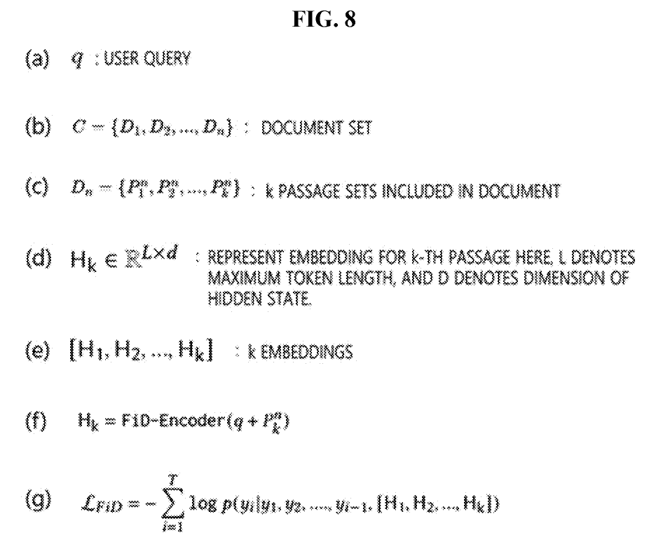

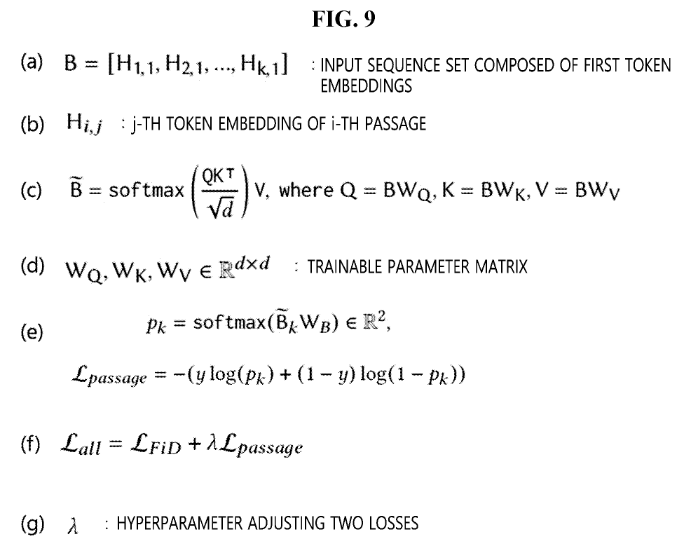

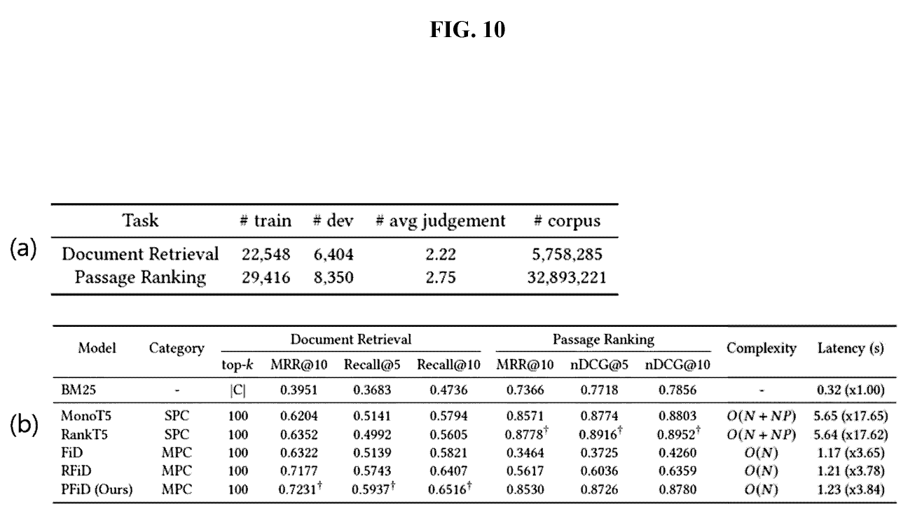

Hereinafter, the present disclosure will be described in more detail with the accompanying drawings. FIG. 1 is a conceptual diagram for describing a system for generating answers based on information retrieval according to the present disclosure. FIG. 2 is a flowchart for describing the method for generating answers based on information retrieval according to the present disclosure, and FIGS. 3A and 3B are conceptual diagrams for describing a method for training an information retrieval model according to the present disclosure. FIGS. 4, 5, 6, and 7A and 7B are conceptual diagrams for describing the method for generating answers based on information retrieval according to the present disclosure, and FIGS. 8 and 9 are mathematical formulas related to the method for generating answers based on information retrieval according to the present disclosure. Furthermore, FIGS. 10, 11, and 12 are tables and graphs illustrating an embodiment of learning results of the information retrieval model trained using a learning method according to the present disclosure.

As illustrated in FIG. 1, a system for generating answers based on information retrieval according to the present disclosure may include at least one of an input unit 110, an output unit 120, a communication unit 130, a storage unit 140, a document retrieval unit 150, an information retrieval model 160, an answer generation unit 170, and a control unit 180. However, the components of the system for generating answers based on information retrieval according to the present disclosure are not limited thereto, and may further include various hardware components that perform the same or similar functions as those described herein.

The system for generating answers based on information retrieval according to the present disclosure may include at least one processor and at least one memory including a computer program code. In this case, the memory may function as the storage unit 140. In present disclosure, the memory and the program code may cooperate with the processor to perform a series of processes described below.

Although not illustrated, the system for generating answers based on information retrieval according to the present disclosure may include one or more processors, in which the processors may include one or more general-purpose processors and/or one or more special-purpose processors (e.g., a digital signal processor, a tensor processing unit (TPU), a graphics processing unit (GPU), a neural network processing unit (NPU), an application-specific integrated circuit (ASIC) or semiconductor device, a field programmable gate array (FPGA), a quantum processing device (or quantum processor (QPU), etc). One or more processors may be configured to execute instructions stored (or included) in the storage unit 140, computer-readable instructions, and/or other instructions described herein. The method and system for generating answers based on information retrieval according to the present disclosure may allow the memory and at least one processor to cooperate to perform data processing as described below. The processor may perform a series of operations and data processing using data and information stored in the memory. In this case, the memory may be a component of the storage unit 140.

In addition, the system for generating answers based on information retrieval according to the present disclosure may perform data processing and calculation processes using a quantum gate, quantum entanglement, and quantum superposition states by considering implementation in a quantum computer environment. For example, the present disclosure may perform a qubit-based parallel operation, and such a quantum operation may operate complementarily with existing classical computers.

The quantum computer may include a high-speed data processing device utilizing the qubit-based parallel operation and the quantum entanglement, and enables hardware-based computation optimization using the FPGA and ASIC. In addition, the quantum computer may utilize a quantum processor capable of the qubit-based parallel operation, and improve data processing efficiency through a hybrid structure with the existing classical computers.

The input unit 110 serves as a means for data input, and may be implemented in various forms. For example, the input unit 110 may be configured to receive the user input. The input unit 110 may be configured to receive the user input from the user terminal 10. Here, "receiving the input" may mean receiving an input signal (or selection signal) corresponding to the user input based on the fact that the input is made by the user through the configuration of the input unit provided in the user terminal 10.

Here, the user terminal 10 may include at least one of a mobile phone, a smart phone, a notebook computer, a laptop computer, a slate PC, a tablet PC, an ultrabook, a desktop computer, a digital broadcasting terminal, a personal digital assistant (PDA), a portable multimedia player (PMP), a navigation device, or a wearable device (e.g., a smartwatch, smart glass, or a head-mounted display (HMD)).

In addition, in the present disclosure, the input unit 110 does not necessarily refer to a hardware means, but may be understood as a channel for receiving input from a user.

The input unit 110 may also be referred to as a user interface module. The input unit 110 may include a touch screen, a computer mouse, a keyboard, a keypad, a touch pad, a trackball, a joystick, a voice recognition module, or other similar devices. However, in the present disclosure, the type of the input unit 110 is not limited.

Here, the user input may include documents, text, images (or videos), speech, etc. In this case, the system for generating answers based on information retrieval may further include a module for converting voice into text.

Next, the output unit 120 may output information through components (e.g., a display unit, a touch screen, a speaker, etc.) of the output unit provided in the user terminal 10 interoperating with the system for generating answers based on information retrieval according to the present disclosure. For example, the output unit 120 may output a page (or service page, 1000) linked to the system for generating answers based on information retrieval according to the present disclosure to the display unit of the user terminal 10. In addition, the output unit 120 does not necessarily refer to hardware means, but may be understood as a channel for outputting results to the user.

Next, the communication unit 130 may be connected to the user terminal 10, a server (e.g., a central server, an external server, etc.), a device, and at least one network, etc. via a wireless or wired network, and may be configured to receive or transmit overall data and information necessary for the operation of the system for generating answers based on information retrieval according to the present disclosure.

The communication unit 130 may support various communication schemes depending on communication standards of a communicating device.

For example, the communication unit 130 may be configured to communicate with a communication target using at least one of wireless LAN (WLAN), wireless-fidelity (Wi-Fi), wireless fidelity (Wi-Fi) direct, digital living network alliance (DLNA), wireless broadband (WiBro), world interoperability for microwave access (WiMAX), high speed downlink packet access (HSDPA), high speed uplink packet access (HSUPA), long term evolution (LTE), long term evolution-advanced (LTE-A), 5th generation (5G) mobile telecommunication, Bluetooth (Bluetooth^{TM}), radio frequency identification (RFID), infrared data association (IrDA), ultra-wideband (UWB), ZigBee, near field communication (NFC), Wi-Fi direct, and wireless universal serial bus (wireless USB) technologies.

Next, the storage unit 140 (or memory) serves to store various data related to the present disclosure and may include one or more non-transitory computer-readable storage media that may be read and/or accessed by at least one of the one or more processors.

One or more computer-readable storage media may include volatile and/or non-volatile storage components, such as optical, magnetic, organic, or other memory or disk storage devices. In some examples, the storage unit 140 may be implemented using a single physical device (e.g., a single optical, magnetic, organic, or other memory, or disk storage device), while in other examples, the storage unit 140 may be implemented using two or more physical devices.

The storage unit 140 may include computer-readable instructions and additional data. The storage unit 140 may include storage necessary to perform at least some of the methods, scenarios, and techniques described herein and/or at least some of the functions of the devices and networks.

Furthermore, at least a portion of the storage unit 140 may be cloud storage or a cloud server. The storage unit 140 may store data corresponding to the user input received from the input unit 110 and at least a portion of the training dataset 200 (or training data). For example, the training dataset 200 may be configured to include a plurality of queries, a plurality of documents, and passages included in each of the plurality of documents.

That is, the storage unit 140 may be sufficient as long as it has a space storing information necessary for the operation of the system for generating answers based on information retrieval according to the present disclosure, and it may be understood that there are no physical space restrictions.

Furthermore, the storage unit 140 may store a computer program including computer program instructions. Furthermore, the storage unit 140 may store a computer program including computer program instructions that control the operation of the system or the operation of the control unit 180 when the computer program instructions are loaded onto the processor of the system.

Next, the document retrieval unit 150 (or document retriever) may be configured to arrange documents or passages according to their relevance to queries. The document retrieval unit 150 may use an artificial intelligence model or algorithm and filter at least one candidate document associated with a query. In this case, it may also be understood that the artificial intelligence model or algorithm is included (or stored) in the document retrieval unit 150.

For example, the artificial intelligence model or algorithm used in the document retrieval unit 150 may include at least one of best matching 25 (BM25) and dense passage retrieval (DPR). The BM25 may be an algorithm that calculates a relevance score of a document based on a word frequency (TF), an inverse document frequency (IDF), a document length, etc., in the query and document. In addition, the DPR is a deep learning-based model that embeds a query with one encoder and a document with another encoder, and then measures relevance with a vector similarity (e.g., inner product) between vectors embedded in each of the two encoders. The DPR uses a bi-encoder structure based on language models (e.g., BERT, RoBERTa, etc.). However, the artificial intelligence model or algorithm used in the document retrieval unit 150 is not necessarily limited thereto, and any artificial intelligence model or algorithm that performs a role identical or similar to the function of the document retrieval unit 150 is sufficient.

Next, the information retrieval model 160 may be configured to simultaneously retrieve documents associated with queries and extract passages associated with queries from within the retrieved documents. That is, the information retrieval model 160 may simultaneously perform the document reranking and passage extraction necessary for content generation. In the present disclosure, the information retrieval model 160 may also be referred to as the "passage fusion-in-decoder (PFiD)”.

Here, the document reranking may refer to a process of arranging (or adjusting), based on the relevance to the user query, the ranking (priority) of a plurality of candidate documents (e.g., a plurality of candidate documents primarily retrieved through the document retrieval unit 150) retrieved during an initial retrieval process in relation to the user query.

For example, when the plurality of candidate documents associated with the query are retrieved through the document retrieval unit 150, the information retrieval model 160 may retrieve at least one relevant document associated with the query among the plurality of candidate documents, and at the same time extract the passage associated with the query from among the passages included in the relevant document.

This information retrieval model 160 may be configured to include at least one of an encoder 161, a decoder 162, and a ranker layer 163 (see FIGS. 3A and 3B). In addition, in the present disclosure, the information retrieval model 160 may be a model trained using the training dataset 200 stored in the storage unit 140 (or memory). The contents of the learning method of the information retrieval model 160 will be described in detail below.

Next, the answer generation unit 170 may be configured to generate an answer to a query. The answer generation unit 170 may generate an answer to a query using a relevant document and passage associated with a query specified based on the output results of the information retrieval model 160.

For example, the answer generation unit 170 may include at least one of a generative model, a foundation model, and a large-scale language model to generate the answer to the query. Alternatively, the answer generation unit 170 itself may be understood as corresponding to at least one of the generative models (e.g., a generative AI model, a foundation model, and a large language model).

Next, the control unit 180 may play a role in controlling the overall operation of the system for generating answers based on information retrieval according to the present disclosure. The control unit 180 may process signals, data, information, etc., input or output through the components of the system for generating answers based on information retrieval described above, or perform a series of data processing to provide or process appropriate information and functions to a user. The control unit 180 may be physically implemented by the processor described above.

The present disclosure is directed to providing a method and system for generating answers based on information retrieval, the method and system being capable of simultaneously improving retrieval efficiency and the accuracy of content generation in comparison with previously known methods and systems. More specifically, the present disclosure is directed to providing an information retrieval module capable of simultaneously improving the retrieval efficiency and accuracy of content generation by simultaneously performing the document reranking and the passage extraction necessary for content generation. The relevance to the user query is determined on a passage-by-passage basis in an information retrieval model, wherein each passage is included in at least one of the plurality of candidate documents. Hereinafter, a method for training the information retrieval model will be described in more detail.

As described above, the information retrieval model 160 according to the present disclosure may be trained using the training dataset 200.

In this regard, the present disclosure describes how to construct (or generate) the training dataset 200 for training the information retrieval model 160. The control unit 180 may construct the training dataset 200 that enables the information retrieval model 160 to simultaneously train document-unit (or level, degree, etc.) relevance and passage-unit (or level, degree, etc.) relevance. More specifically, the control unit 180 may construct the training dataset 200 such that the information retrieval model 160 may simultaneously perform relevance determination for the entire document and relevance determination for each passage included in the document through a single training session. In particular, in the present disclosure, a document including at least one relevant passage (or positive passage) may be set as a relevant document (or positive document) to construct the training dataset 200 (see FIG. 10A).

The training dataset 200 may be configured to include at least one of a query, a document, a label for the entire document, and a label for each passage included in the document. The label for the entire document may be assigned based on whether the document is relevant to the query. In addition, the label for each passage may be assigned based on whether each passage included in the document is relevant to the query.

Here, the label for the document may include a plurality of respectively different labels. For example, the label for the document may include a first label (“1(True)”) or a second label (“0 (False)”), depending on whether the passage included in the document is relevant to the query.

In addition, the label for each passage (i.e., the label for each passage) may include the plurality of respectively different labels. For example, the label for each passage may include the first label (“1”) or the second label (“0”), depending on whether each passage included in the document is relevant to the query.

In an embodiment, when the relevant passage (e.g., a passage with a passage relevance (passage relevance) score of "1" or a passage label of "1") that is relevant to the query exists among the passages included in the plurality of documents, the control unit 180 may perform labeling on the document including the relevant passage such that the first label among the plurality of labels is assigned to the document. The document assigned the first label may also be referred to as the "relevant document" or the "positive document”.

Conversely, if a specific document does not have a passage associated with a query among the passages included in the document (e.g., all passages have a passage relevance score of "0" or all passages have a label of "0"), the control unit 180 may perform labeling on a specific document such that the second label among the plurality of labels is assigned to the specific document. The document assigned the second label may also be referred to as a "non-relevant document" or a "negative document”.

That is, the control unit 180 may perform the labeling on the relevant document (e.g., document A: passage1(0), passage2(1), and passage3(0)) that includes at least one relevant passage associated with the query such that the first label among the plurality of labels is assigned to the document. On the other hand, the control unit 180 may perform the labeling on the document such that the second label among the plurality of labels is assigned to the document (e.g., document B: passage1(0), passage2(0), and passage3(0)) that does not include the relevant passage associated with the query at all. Through this, a document-unit relevance label and a passage-unit relevance label for each passage within the document are assigned to one document together, so the training dataset 200 capable of simultaneously training the document-unit relevance and the passage-unit relevance may be constructed.

In this way, according to the present disclosure, by configuring a single dataset such that the single dataset includes both a label for the entire document and labels for each passage included within the document, it is possible to construct a learning environment in which the information retrieval model 160 may simultaneously perform a relevance determination for the entire document and a relevance determination for each passage through a single training session.

Meanwhile, the control unit 180 may use the constructed training dataset 200 to perform learning (e.g., supervised learning) for the information retrieval model.

Given the query and the plurality of candidate documents (or passage sets), the goal of the information retrieval model 160 is to extract k relevant documents most associated with the query from among the plurality of candidate documents (see (a) and (b) of FIG. 8). For example, it is assumed that a query included in the training dataset 200 and a set of k passages included in at least one candidate document are given (see (c) of FIG. 8). The control unit 180 may configure (or generate) input data for the information retrieval model 160 including the query and k passages.

Specifically, the control unit 180 may configure the input data in such a way that the query and the specific passage included in the plurality of candidate documents form a pair. The control unit 180 may configure the input data such that the query and the specific passage among the passages included in each of the plurality of candidate documents form a pair. In this case, when there are a plurality of specific passages, the input data may include a plurality of specific passages.

In an embodiment, as illustrated in FIGS. 3A and 3B, the control unit 180 may configure input data (first input data 301) in such a way that a query 300 and a first passage 301a among the passages included in the plurality of candidate documents form a pair. In addition, the control unit 180 may configure input data (second input data 302) in such a way that the query 300 and a second passage 302a among the passages included in the plurality of candidate documents form a pair. In addition, the control unit 180 may configure input data (third input data 303) in such a way that the query 300 and a third passage 303a among the passages included in the plurality of candidate documents form a pair.

Here, the size (or length) of the passages included in the input data may be distinguished according to preset criteria. The preset criteria may be set in various ways, taking into account the efficiency of the information retrieval model 160 (e.g., considering a stable size that may be input to the encoder 161). For example, i) the number of tokens included in one passage may be set to 256 tokens or 522 tokens, or ii) the specific passage may be set to be divided into 256 tokens, and another passage may be set to be divided in a direction that overlaps some of the tokens of the specific passage. Such preset criteria may be set variously by an administrator (or user) of the system for generating answers based on information retrieval or by the system for generating answers based on information retrieval itself.

The control unit 180 may process the input data 301, 302, and 303 as input to the encoder 161 of the information retrieval model 160 to specify the relevant document associated with the query among the plurality of candidate documents. The encoder 161 outputs an embedding for a k-th passage (see (d) of FIG. 8), where L may represent a maximum token length and d may represent a dimension of a hidden state. More specifically, the encoder 161 may be configured to perform an interaction between the query 300 included in the input data 301, 302, and 303 and the specific passages 301a, 302a, and 303a to generate embedding vectors 311, 312, and 313 corresponding to the input data 301, 302, and 303. In the present disclosure, the encoder 161 may also be referred to as a “cross-encoder”. In addition, in the present disclosure, the embedding vector corresponding to the output of the encoder 161 may also be referred to as a "hidden vector”, "hidden state vector”, "feature vector”, "semantic representation”, or "semantic representation vector”.

Here, the embedding vectors 311, 312, and 313 may represent how semantically related the query 300 and the specific passages 301a, 302a, and 303a are, based on the similarity of the semantic expressions between the query 300 and the specific passages 301a, 302a, and 303a. The embedding vectors 311, 312, and 313 are numerical information that expresses the semantic relation (or semantic relationship, semantic relevance, etc.) between the query 300 and the passages 301a, 302a, and 303a. For example, the embedding vectors 311, 312, and 313 may be understood as an n-dimensional vector that compressively expresses (summarizes) a similarity between the query and the passage, associated topics, the likelihood that the passage will provide an answer, a degree to which the passage matches the information requested in the question, semantic distance, and the like. In other words, the embedding vectors 311, 312, and 313 may be vectors that include how meaningful the passages 301a, 302a, and 303a paired with the query 300 are to the query 300.

In an embodiment, assume that the query included in the input data is "What does PFID stand for”" and the passage is an abbreviation of the "PFID stands for Passage Fusion-in-Decoder”. When the input data is input to the encoder 161, the encoder 161 may analyze the semantic relevance and/or semantic features of the input data to generate an embedding vector (embedding vector with high relevance) exhibiting high relevance.

In another embodiment, assume that the query included in the input data is "What does PFID stand for”", the passage is "the RAG is an abbreviation of Retrieval-Augmented Generation, and a natural language processing (NLP) technology that combines information retrieval and generative models”. When the input data is input to the encoder 161, the encoder 161 may analyze the semantic relevance and/or semantic features of the input data to generate a vector (embedding vector with low relevance) exhibiting low relevance.

In this way, even if the query is identical, the resulting generated (or output) vector may vary depending on the passage paired with the query.

The control unit 180 may input the plurality of input data 301, 302, and 303, each including the query 300 and the plurality of specific passages 301a, 302a, and 303a, to the encoder 161, and acquire the embedding vectors 311, 312, and 313 corresponding to each of the plurality of input data 301, 302, and 303 from the encoder 161.

Furthermore, the control unit 180 may use the plurality of the embedding vectors 311, 312, and 313 acquired from the encoder 161 to determine the relevance to the query 300 for each passage 301a, 302a, and 303a which is included in each of the plurality of candidate documents and distinguished based on the preset criteria.

In this regard, the information retrieval model 160 of the present disclosure may be trained to simultaneously perform the document reranking and the passage extraction necessary for answer (or content) generation. More specifically, the information retrieval model 160 may be trained to simultaneously determine the relevance between the query and the entire document and the relevance between the query and each of a plurality of passages.

First, the control unit 180 may process the plurality of the embedding vectors 311, 312, and 313 as input to the decoder 162 of the information retrieval model 160 to determine the relevance between the plurality of candidate documents and the query 300.

In this case, the control unit 180 may combine (or concatenate) the plurality of the embedding vectors 311, 312, and 313 to generate a combined embedding vector 320 and input the combined embedding vector 320 to the decoder 162 in order to determine the relevance to the query 300 for each of the plurality of candidate documents (see (f) of FIG. 8).

When the encoding is completed independently (or individually) for input data (e.g., the plurality of input data 301, 302, and 303) including the query and the passages included in each of the plurality of candidate documents, the control unit 180 may combine the encoding results of the passages belonging to the same candidate document into a single vector (or sequence) to generate the document-unit combined vector.

More specifically, the control unit 180 utilizes the encoder 161 to acquire the embedding vectors 311, 312, and 313 for each input data (e.g., the plurality of input data 301, 302, and 303) including the query and the passages included in each of the plurality of candidate documents, and sequentially combines embedding vectors belonging to a specific candidate document to generate the combined embedding vector 320 corresponding to the specific document. Thereafter, the combined embedding vector 320 is used as input to the decoder 162, thereby enabling the determination of the relevance to the query and the cross-comparison between the passages for each document.

In this case, the passages included within each of the plurality of candidate documents are processed independently, and the vector combination may be performed for each candidate document. As a result, the passage information is prevented from being mixed between the documents, thereby improving ranking accuracy and efficiency at the document level. For example, the control unit 180 may independently and repeatedly perform vector combination and decoding processes on each candidate document at the document level, thereby ensuring that encoding results of passages between respectively different documents are not mixed. This ensures that semantic expressions are preserved at each document level, and the correlations between the passages are considered only within the corresponding document, thereby improving the accuracy of the relevance determination for each document.

The combined embedding vector 320 may represent the entire semantic relevance between the query 300 and the passages 301a, 302a, and 303a included in the plurality of candidate documents. The combined embedding vector 320 may be data that compresses all relationships between the passages 301a, 302a, and 303a included in the plurality of candidate documents and the query 300. The process of combining the embedding vectors may be a process of concatenating all the passages in the document into a single long sequence to represent what meaning the passages have for the query such that the decoder 162 may comprehensively determine whether the entire document is relevant to the query. In other words, the combined embedding vector 320 includes information that comprehensively reflects the relationships between all the passages included in the document and the query, and the decoder 162 may be trained to make a final determination on the relevance between the entire document and the query based on this information. In the present disclosure, the combined embedding vector 320 may also be referred to as a "combined embedding vector sequence" or a "combined vector sequence”.

The decoder 162 of the information retrieval model 160 may be trained to determine the relevance to the query 300 for each of the plurality of candidate documents to the query 300 using the combined embedding vector 320.

For example, the decoder 162 may recognize the combined embedding vector 320 as a summary of the document and analyze, by an attention operation, the relevance between the passages, the likelihood of answer to the query generated by the combination of passages, hidden dependencies between passages, etc. Finally, the decoder 162 may be trained to classify whether a specific document is a relevant document associated with a query or is a non-relevant document.

That is, the decoder 162 may recognize the combined embedding vector 320 as a sequence-to-label problem, and softly train which passages contribute significantly to the document relevance using an attention mechanism. Here, the attention may be a process of automatically extracting which passages are more important among the plurality of passages included in the document. As a result, the output of the decoder 162 may also be understood as a collective determination result regarding the overall consistency between the document and the query. That is, the decoder 162 may be trained to assign high attention to passage vectors with relevance and ignore passage vectors without relevance.

In this way, according to the present disclosure, the decoder 162 may be trained to receive the combined vector 320 as input and generate a document-level relevance word token (e.g., True or False 330).

Here, the relevance word token 330 may mean a token representing whether there is relevance between the query 300 and the document. The relevance word token 330 may be configured to include a first relevance word token (e.g., “True”) or a second relevance word token (e.g., “False”), depending on whether there is relevance between the query 300 and the document. The first relevance word token (e.g., “True”) may represent that the document is relevant to the query 300, and the second relevance word token (e.g., “False”) may represent that the document is not relevant to the query 300.

Furthermore, a loss function (or first loss function) for training the information retrieval model 160 (or decoder 162) that predicts (or generates) the relevance word tokens 330 for each of the plurality of candidate documents may be represented as illustrated in (g) of FIG. 8. The first loss function may be a loss function for training and evaluating how accurately the decoder 162 generates a correct token sequence (i.e., correct relevance word token) based on information integrated (or fused) between passages within a document.

The first loss function may be understood as a loss function for reducing the loss in generating (or predicting) the relevance word tokens for determining the relevance for the entire document (or a set of all passages included in the document). The first loss function is used in the learning process for determining the relevance at the document level, and the decoder 162 may be trained to minimize (or reduce) the difference (or error) between the predicted (or generated) relevance word token (or generated relevance word token, predicted relevance word token, etc.) for the document and the correct relevance word token (or target relevance word token) through the first loss function.

That is, the control unit 180 may calculate the loss between the correct relevance word token for the document and the generated relevance word token generated by the decoder 162 using the loss function illustrated in (g) of FIG. 8, and perform training on the decoder 162 such that the loss is reduced.

In this way, the control unit 180 may train the decoder 162 of the information retrieval model 160 in a direction that reduces the loss of the first loss function, so the decoder 162 may generate the correct token sequence such as "true" or "false" by utilizing passage information close to the ground truth among the given passages.

Next, the control unit 180 may process the plurality of the embedding vectors 311, 312, and 313 as inputs to a ranker layer (or module 163) of the information retrieval model 160 to determine the relevance between the passages 301a, 302a, and 303a included in each of the plurality of candidate documents and the query 300. In the present disclosure, the ranker layer 163 may also be named as an “inter-passage attention layer (or module)”, a “passage relevance scoring layer (or module)”, a “passage relevance modeling layer (or module)”, a “self-attention layer (or module)”, etc.

In the present disclosure, the ranker layer 163 may be trained to determine the relevance to the query 300 for each passage 301a, 302a, and 303a included in the plurality of candidate documents using the plurality of embedding vectors 311, 312, and 313. More specifically, the ranker layer 163 may be trained to generate (or predict, produce, etc.) a passage relevance score (or point 340) for each passage 301a, 302a, and 303a included in each of the plurality of candidate documents based on the relevance determined using the plurality of the embedding vectors 311, 312, and 313.

Here, the passage relevance score 340 may be a score representing whether there is relevance between the passages 301a, 302a, and 303a included in each of the plurality of candidate documents and the query 300. The passage relevance score 340 may be configured to include a first score (e.g., “ 1”) or a second score (e.g., “ 0”) depending on whether there is relevance between each of the plurality of passages 301a, 302a, and 303a and the query 300. The first score (e.g., “1 ”) may represent that the passage is relevant to the query 300, and the second score (e.g., “0 ”) may represent that the passage is not relevant to the query 300.

The ranker layer 163 may be trained to predict a relative similarity between the passages 301a, 302a, and 303a included in the plurality of candidate documents by using (or applying) the inter-passage attention mechanism (e.g., inter-passage attention) for the plurality of the embedding vectors 311, 312, and 313. Here, the relative similarity may refer to a measure (or relationship) that expresses, on a relative basis, how much more relevant each passage is to the query compared to other passages among a plurality of passages given for the same query.

More specifically, the ranker layer 163 trains relationships representing how similar each passage is to each other. Through this, the information retrieval model 160 may recognize and evaluate not only the relevance of individual passages but also the relative importance or similarity between the plurality of passages. For example, the ranker layer 163 may not only evaluate the relevance between the passages 301a, 302a, and 303a included in the plurality of candidate documents and the query 300, but may also compare and train the relative similarity and/or importance, such as which one of the plurality of passages 301a, 302a, and 303a is more important to the query 300 or which passage is less important to the query. The comparison may be performed using the inter-passage attention mechanism.

In this regard, the control unit 180 may utilize the inter-passage attention mechanism described above to explicitly model the interactions between passages 301a, 302a, and 303a included in the plurality of candidate documents. The control unit 180 may construct a set of input sequences by concatenating the embeddings of the first tokens for each pair (see (a) of FIG. 9). Here, a j-th token embedding of an i-th passage may be represented as illustrated in (b) of FIG. 9. The control unit 180 may also extend the use of the token to express the relative meaning between the passages through the self-attention mechanism.

The control unit 180 considers a single-layer transformer model to represent (or model) the relative relevance between the passages, as illustrated in (c) of FIG. 9. For example, the ranker layer 163 may be implemented based on the self-attention structure of the transformer, and configured to explicitly learn the relative similarity among passages through the interactions between the hidden states of the first tokens of each passage.

Here, learnable parameters (or parameter matrices) may be represented as illustrated in (d) of FIG. 9, and information between passages may be mutually fused and exchanged through the self-attention mechanism.

Furthermore, the loss function (or second loss function) used for the inter-passage attention learning of the information retrieval model 160 (or ranker layer 163) may be represented as illustrated in (e) of FIG. 9. Here, y may represent a passage relevance label. The second loss function is intended for learning the relative relevance between the passages and may be understood as a loss function in a binary classification problem that predicts whether a passage is relevant to a query. The ranker layer 163 may perform the attention-based learning between the passages using the second loss function.

More specifically, the second loss function is a loss function designed to increase the accuracy of the relevance determination at the passage level, and may be a loss function for enabling the ranker layer 163 to explicitly distinguish and learn whether a passage is relevant to a given query or not. To improve the passage-unit ranking performance, the control unit 180 may train the ranker layer 163 to minimize the error (or difference) between a correct label y of each passage and the predicted probability using the second loss function.

In order to increase the accuracy of determining the relative relevance of the passages to the query, the ranker layer 163 may be trained to minimize (or reduce) the difference between the passage relevance score predicted (or generated) for each passage and the passage relevance score corresponding to the ground truth (or target) through the second loss function that reduces the binary classification error (relevant passage (e.g., “True ”) or unrelated passage (e.g., “ False”)) for each passage.

That is, the control unit 180 may use the second loss function illustrated in (e) of FIG. 9 to calculate the loss between the passage relevance score predicted by the ranker layer 163 and the passage relevance score corresponding to the ground truth (or target), for each passage to query, and perform training on the ranker layer 163 such that the loss is reduced.

In this way, the ranker layer 163 may generate a probability distribution (e.g., “- presence of relevance” or “- absence of relevance”) determining whether each passage included in a document is relevant to the query or not, by performing training such that the predicted probability of determining the relevance between the passage and the query becomes actually closer to the ground truth.

Meanwhile, the loss function (or third loss function, final loss function, etc.) for the final training of the information retrieval model 160 including the encoder 161, the decoder 162, and ranker layer 163 described above may be represented as illustrated in (f) of FIG. 9. The final loss function may also be understood as a final objective function (or target function) for training the multi-granularity ranking of the information retrieval model 160.

The final loss function may be the overall loss function for simultaneously training document relevance determination and passage relevance determination. More specifically, the final loss function may be a loss function aimed at training the information retrieval model 160 to simultaneously predict "whether a document is relevant to the query" and "which passage is key” well. Here, hyperparameters that control the two losses (e.g., document relevance determination results and passage relevance determination results) may be represented as illustrated in (g) of FIG. 9.

That is, the information retrieval model 160 may be trained to accurately rank relevant documents and relevant passages simultaneously through the final loss function. Through this learning process, the present disclosure may simultaneously improve the retrieval efficiency and accuracy by processing the document reranking and the passage extraction as a single integrated process, and acquire the information retrieval model 160 optimized for passage-based information extraction and enhanced RAG connectivity.

Meanwhile, as illustrated in FIG. 2, at the inference stage, the method and system for generating answers based on information retrieval, which includes the information retrieval model 160 trained according to the learning method described above may provide a more accurate and relevant answer to a query to a user through a process (S210) of receiving a user query from a user terminal, a process (S220) of specifying a plurality of candidate documents associated with a user query based on preset criteria, a process (S230) of determining the relevance to the user query on a passage-by-passage basis for each passage included in at least one of the plurality of candidate documents and distinguished based on the preset criteria, a process (S240) of specifying a relevant document associated with the user query among the plurality of candidate documents based on the relevance to the user query determined for each passage included in the plurality of candidate documents, and a process (S250) of generating the answer to the user query using the relevant document. The answer is provided to the user terminal.

As illustrated in FIG. 4, when a user query 400 input from a user terminal 10 via a service page 1000 is received by the control unit 180, the control unit 180 may specify the plurality of candidate documents 401 and 402 associated with the user query 400 based on preset criteria. Here, the preset criteria may be associated with a retrieval criterion (e.g., BM25 score) of the document retrieval unit 150 that initially specifies the document associated with the query from the entire document set (or a large document corpus, a training dataset, etc.) based on the user query 400. Each of the plurality of documents 401 and 402 may be configured to include at least one passage (or a plurality of passages).

In addition, the control unit 180 may configure input data such that the user query 400 and the specific passages among the passages included in the plurality of candidate documents 401 and 402 form a pair. In this case, when there are the plurality of specific passages, the input data may include the plurality of specific passages.

For example, the control unit 180 may configure input data (first input data 411) that uses the user query 400 and a first specific passage 411a among the passages included in the plurality of candidate documents 401 and 402 as a pair. In addition, the control unit 180 may configure input data (second input data 412) that uses the user query 400 and a second specific passage 412a among the passages included in each of the plurality of candidate documents 401 and 402 as a pair. In addition, the control unit 180 may configure input data (Nth input data 413) that uses the user query 400 and an Nth specific passage 413a among the passages included in the plurality of candidate documents 401 and 402 as a pair.

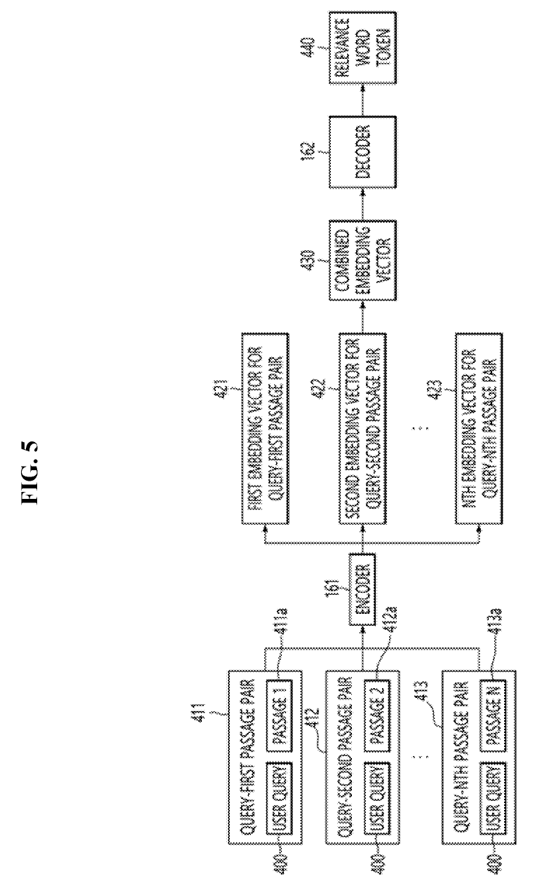

Next, as illustrated in FIG. 5, the control unit 180 may input, to the encoder 161 of the information retrieval model 160, input data 411, 412, and 413 to specify the relevant document associated with the user query 400 among the plurality of candidate documents 401 and 402. The encoder 161 may perform the interaction between the user query 400 included in the input data 411, 412, and 413 and a specific passage 411a, 412a, and 413a, thereby acquiring the embedding vector corresponding to the input data 411, 412, and 413. In this case, based on the fact that each input data 411, 412, and 413 includes the plurality of specific passages 411a, 412a, and 413a, the embedding vectors acquired from the encoder 161 may be plural. That is, based on the fact that the plurality of input data 411, 412, and 413 are input to the encoder 161, the control unit 180 may acquire the embedding vector 421, 422, and 423 corresponding to each of the plurality of input data 411, 412, and 413 from the encoder 161.

Here, the embedding vectors 421, 422, and 423 may represent how semantically related the user query 400 and the specific passage 411a, 412a, and 413a are, based on the similarity of the semantic expressions between the user query 400 and each of the specific passages 411a, 412a, and 413a. The embedding vectors 421, 422, and 423 are numerical information that expresses the semantic relation (or semantic relationship, semantic relevance, etc.) between the user query 400 and the specific passages 411a, 412a, and 413a. For example, the embedding vectors 421, 422, and 423 may be understood as n-dimensional vectors that compressively express (summarize) a similarity between the query and the passage, associated topics, the likelihood that the passage will provide an answer, a degree to which the passage matches the information requested in the question, semantic distance, and the like. That is, the embedding vectors 421, 422, and 423 may be a vector incorporating information about how significant the specific passage 411a, 412a, and 413a paired with a user query 400 is to the user query 400.

The control unit 180 may use the plurality of embedding vectors 421, 422, and 423 acquired from the encoder 161 to determine a relevance to the user query 400, for each passage 411a, 412a, and 413a included in the plurality of candidate documents 401 and 402, the candidate documents having been distinguished from other documents based on the preset criteria.

In this regard, the information retrieval model 160 of the present disclosure may be a model trained to simultaneously perform the document reranking and the passage extraction necessary for answer (or content) generation. More specifically, the information retrieval model 160 may be a model trained to simultaneously perform the determination of the relevance between the query and the entire document and the relevance between the query and each of a plurality of passages.

First, the control unit 180 may input a plurality of embedding vectors 421, 422, and 423 to the decoder 162 of the information retrieval model 160 to determine the relevance between the plurality of candidate documents 401 and 402 and the user query 400. In this case, the control unit 180 may combine (or concatenate) the plurality of embedding vectors 421, 422, and 423 to determine the relevance to the user query 400, for each of the plurality of candidate documents 401 and 402, thereby generating the combined embedding vector 430, and input the combined embedding vector 430 to the decoder 162.

In this case, the control unit 180 may distinguish and sequentially combine the generated embedding vectors 421, 422, and 423 using the encoder 161 for each document (or at the document level), for each of the input data (e.g., the plurality of input data 301, 302, and 303) including the query and the passages 411a, 412a, and 413a included in the plurality of candidate documents 401 and 402, and define the combined embedding vector 430 as the integrated embedding vector (or semantic representation) of the corresponding candidate document. The combined embedding vector for each candidate document is processed as an input to the decoder 162, and processing may be performed for determining relevance at the document level or comparing the relative relevance between the passages.

In this case, in the present disclosure, the vector combination is performed only for the passages included in the same candidate document, and the embedding vectors of the passages included in each of the respectively different candidate documents are configured so as not to be mutually combined, thereby ensuring that the decoding is performed while maintaining semantic consistency for each document.

As an embodiment, it is assumed that a first embedding vector and a second embedding vector corresponding to the input data including the passage included in the first candidate document 401 among the plurality of candidate documents 401 and 402 and the user query 400 are generated through the encoder 161. The control unit 180 may combine the first embedding vector and the second embedding vector belonging to the first candidate document 401 to generate the combined embedding vector corresponding to the first candidate document 401.

As another embodiment, it is assumed that a third embedding vector and a fourth embedding vector corresponding to the input data including the passage included in the second candidate document 402 among the plurality of candidate documents 401 and 402 and the user query 400 are generated through the encoder 161. The control unit 180 may combine the third embedding vector and the fourth embedding vector belonging to the second candidate document 402 to generate the combined embedding vector corresponding to the second candidate document 402.

Thereafter, the combined embedding vector corresponding to the first candidate document 401 and the combined embedding vector corresponding to the second candidate document 402 are each processed as inputs to the decoder 162, thereby enabling the relevance determination for the query and the cross-comparison between the passages for each candidate document.

This combined embedding vector 430 may represent the entire semantic relevance between the user query 400 and the passages 411a, 412a, and 413a included in the plurality of candidate documents 401 and 402. The combined embedding vector 430 may be data that compresses all relationships between the passages 411a, 412a, and 413a included in the plurality of candidate documents 401 and 402 and the user query 400. In other words, the combined embedding vector 430 may be understood as information that comprehensively reflects the relationships between the query and all the passages included in the plurality of candidate documents 401 and 402.

As described above, the decoder 162 may be configured to predict a relevance word token 440 for each of the plurality of candidate documents 401 and 402. The decoder 162 may be configured to generate the relevance word token 440 for each of the plurality of candidate documents 401 and 402 based on the relevance determined using the combined embedding vector 430. Here, the relevance word token 440 may mean a token representing whether the user query 400 is relevant to each of the plurality of candidate documents 401 and 402. The relevance word token 440 may be configured to include a first relevance word token (e.g., “True”) or a second relevance word token (e.g., “False”) depending on whether the user query 400 is relevant to each of the plurality of candidate documents 401 and 402. The first relevance word token (e.g., “True”) may represent that the candidate document is a relevant document that is related to the user query 400, and the second relevance word token (e.g., “False”) may represent that the candidate document is a document that is not relevant to the user query 400.

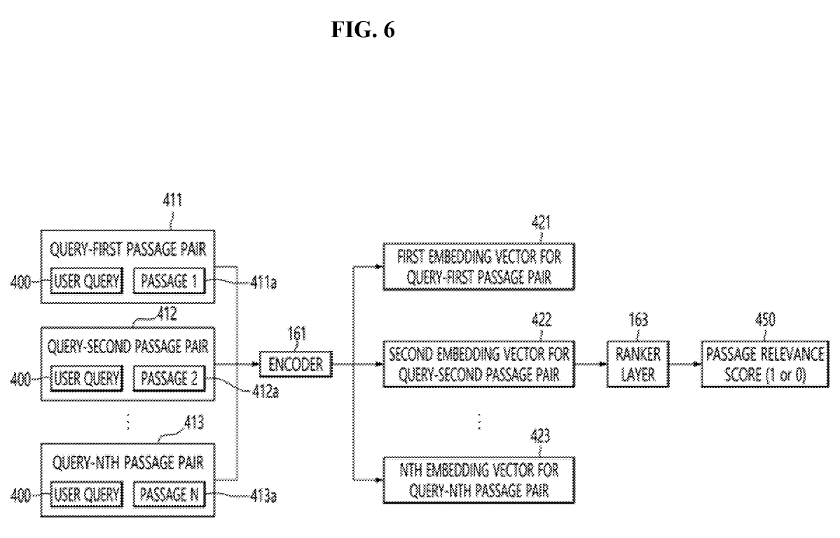

Next, as illustrated in FIG. 6, the control unit 180 may process the plurality of embedding vectors 421, 422, and 423 as input to the ranker layer 163 of the information retrieval model 160 to determine the relevance to the user query 400 for each passage 411a, 412a, and 413a included in the plurality of candidate documents 401 and 402.

As described above, the ranker layer 163 may be a layer trained to predict the relative similarity between the passages 411a, 412a, and 413a included in the plurality of candidate documents 401 and 402 by utilizing (or applying) the inter-passage attention mechanism (e.g., inter-passage attention) for the plurality of embedding vectors 421, 422, and 423. Here, the relative similarity may refer to a measure (or relationship) that expresses, on a relative basis, how much more relevant each passage is to the query compared to other passages among a plurality of passages given for the same query.

The ranker layer 163 may be configured to determine the relevance to the user query 400 for each passage 411a, 412a, and 413a included in each of the plurality of candidate documents 401 and 402 using the plurality of embedding vectors 421, 422, and 423. More specifically, the ranker layer 163 may generate (or predict, produce, etc.) a passage relevance score 450 (or point) for each passage 411a, 412a, and 413a included in the plurality of candidate documents 401 and 402 based on the determined relevance using the plurality of embedding vectors 421, 422, and 423.

Here, the passage relevance score 450 may be a score representing whether there is relevance between the user query 400 and each of the passages 411a, 412a, and 413a included in the plurality of candidate documents 401 and 402. The passage relevance score 450 may be configured to include a first score (e.g., “1”) or a second score (e.g., “0”) depending on whether there is relevance between the user query 400 and each of the plurality of passages 411a, 412a, and 413a. The first score (e.g., “1”) may represent that the passage is relevant to the user query 400, and the second score (e.g., “0”) may represent that the passage is not relevant to the user query 400.

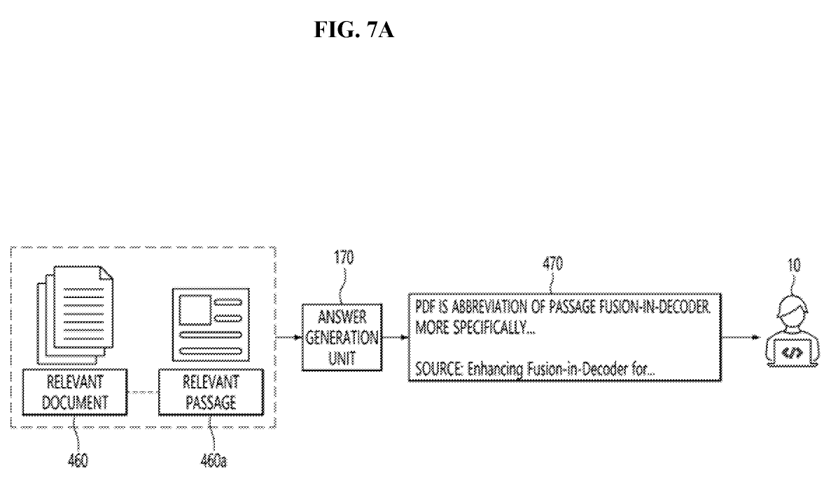

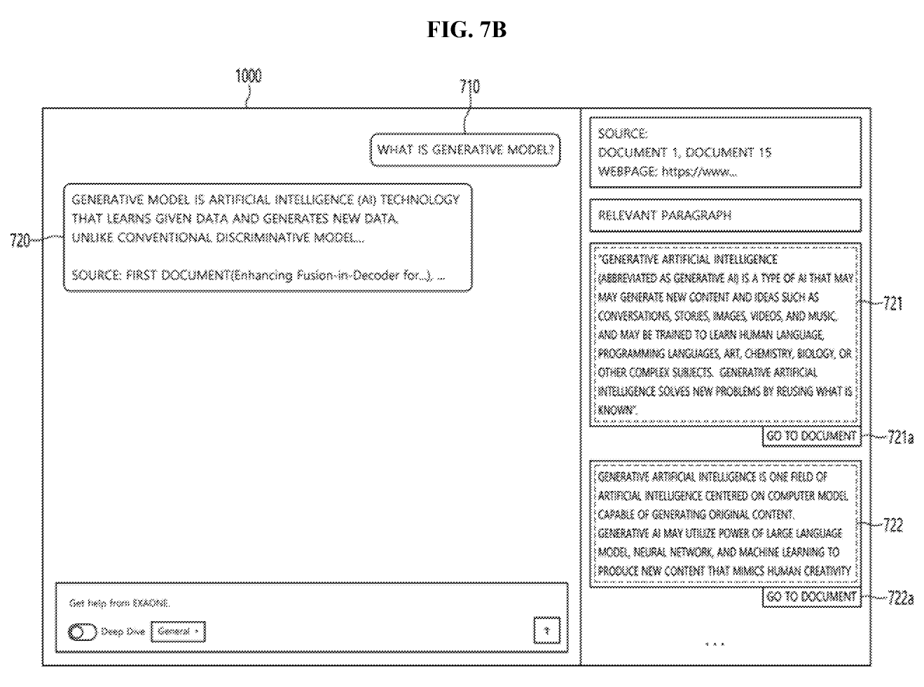

Furthermore, as illustrated in FIG. 7A, the control unit 180 may specify a relevant document 460 associated with the user query from among the plurality of candidate documents 401 and 402 based on the relevance to the user query 400 determined for each passage 411a, 412a, and 413a included in the plurality of candidate documents 401 and 402.

The control unit 180 may specify, among the plurality of candidate documents 401 and 402, the document including the first relevance word token as the relevant document associated with the user query 400. For example, it is assumed that the relevance word token for the first candidate document 401 among the plurality of candidate documents 401 and 402 is generated as “True” and the relevance word token for the second candidate document 402 is generated as “False”. The control unit 180 may specify the first candidate document 401 including the first relevance word token among the plurality of candidate documents 401 and 402 as a relevant document 460 associated with the user query 400.

In addition, the control unit 180 may specify a relevant passage 460a associated with the user query 400 among the passages 411a, 412a, and 413a included in the plurality of candidate documents 401 and 402 to generate the answer to the user query 400. The control unit 180 may specify the passage that satisfies the preset criteria among passages 411a, 412a, and 413a included in the plurality of candidate documents 401 and 402 as the relevant passage 460a. Here, the preset criteria may be set based on the passage included in the relevant document 460 associated with the user query 400. Therefore, the relevant passage 460a may correspond to the passage included in the relevant document 460 associated with the user query 400.

Finally, the control unit 180 may generate an answer 470 to the user query 400 using the relevant document 460 and the relevant passage 460a included in the relevant document 460, and may provide the generated answer 470 to the user terminal 10. For example, the control unit 180 may input the relevant document 460 and the relevant passage 460a to the answer generation unit 170 (e.g., a large language model), and the answer generation unit 170 may generate the answer 470 to the user query 400 using the relevant document 460 and the relevant passage 460a.

In this way, the relevant passage is input as part of the input prompt of the large language model, and the large language model refers to the corresponding passage when generating the answer. That is, the key concepts, numbers, definitions, and claims of specific sentences or passages within the relevant document may be summarized or reconstructed and reflected in the response to the query. Therefore, users may receive an accurate and contextually appropriate optimal answer to their queries, rather than a simple summary.

Users may have a user account pre-registered in the system for generating answers based on information retrieval according to the present disclosure. In this case, the account may be created through a page (or screen) linked to the system for generating answers based on information retrieval. Conversely, the account can also be generated in at least one other system linked to the system for generating answers based on information retrieval. However, in this specification, the system from which the user account was issued is not specifically distinguished, and all accounts that may utilize the various services (or functions) provided by the system for generating answers based on information retrieval according to the present disclosure are referred to as "account pre-registered in the system for generating answers based on information retrieval”.

Accordingly, various pieces of information associated with the user account may be stored in the storage unit 140 of the system for generating answers based on information retrieval. Here, the information associated with the user account may include at least one of user (or user account) history information and user metadata (e.g., name, gender, age, major, occupation, workplace (or company), etc.).

More specifically, the user's history information may include information associated with various events occurring in the user account. For example, the events occurring in the user account may include at least one of i) inputting the user query to obtain an answer from the large language model 170, ii) inputting (or selecting) a document, and iii) inputting a new (or additional) query for an answer generated from the large language model 170.

Based on these events, the user's history information may include at least one of i) a user query input by a user, ii) a document (or document input history of a user) input by a user, iii) content (e.g., passages included in the document, passages associated with the user query, etc.) extracted from the document input by the user, and iv) an answer to the user query from the large language model 170.

Accordingly, at least one of the document, the content extracted from the document, the user query, and the answer to the user query may be stored in the storage unit 140 of the system for generating answers based on information retrieval by being linked to the user account.

In this case, the document stored in the storage unit 140 linked to the user account may be stored in various ways. In the present disclosure, the document received based on the user input or the space storing the user's document may also be referred to as "user DB”, "user document DB”, “document DB”, or the like.

In an embodiment, the system for generating answers based on information retrieval may interoperate with the user terminal 10 and store at least one document stored (or built-in) in the storage (or memory, storage space, database) of the user terminal 10 by linking the document to the user account.

In another embodiment, the system for generating answers based on information retrieval may interoperate with an external cloud storage service (e.g., LG Cloud, Google Drive, Dropbox, etc.) that stores the user's document. The system for generating answers based on information retrieval may store the user's document stored in the cloud storage service by linking to the user account in the storage unit 140.

As illustrated in FIG. 7B, when receiving the user query 710, the system for generating answers based on information retrieval may specify the plurality of candidate documents associated with the user query 710 based on the preset criteria. Furthermore, the system for generating answers based on information retrieval may specify a relevant document associated with the user query 710 among the plurality of candidate documents based on the relevance to the user query 710 determined for each passage included in the plurality of candidate documents, and may generate an answer 720 to the user query 710 using the relevant document.

In this case, the plurality of candidate documents associated with the user query 710 specified based on the preset criteria may be the plurality of candidate documents retrieved through the document retrieval unit 150 or the plurality of candidate documents retrieved from the user DB. That is, the system for generating answers based on information retrieval may specify the plurality of candidate documents associated with the user query 710 from the user DB to generate the answer to the user query 710. For example, the system for generating answers based on information retrieval may specify the plurality of candidate documents associated with the user query 710 among the documents included (or stored) in the user DB, and may generate an answer 720 to the user query 710 using the relevant document associated with the user query 710, where the relevant document was selected from among the specified candidate documents.

Furthermore, the system for generating answers based on information retrieval may provide the answer to the user terminal 10 along with information on the relevant document used to generate the answer. In this case, the information on the relevant document used in the process of generating the answer 720 may be provided along with the answer 720 on the user terminal 10 where the service page 1000 is displayed.

In this case, the system for generating answers based on information retrieval may provide the information on the relevant documents in various ways. For example, the system for generating answers based on information retrieval may automatically identify and highlight sentences, keywords, numbers, etc., that are the basis of actual response contents within the relevant document or the relevant passage specified through the user DB. The system for generating answers based on information retrieval includes the document associated with the user query 710 and may highlight passages 721 and 722 associated with the user query 710 on an area of the service page 1000. In this case, graphic objects 721a and 722a linked to a function that allows a user to view or move to the relevant document may be provided on the area of the service page 1000 where the related passages 721 and 722 are provided.

In this way, when the plurality of relevant passages are selected, the user may contribute to the generation of the answer and the present disclosure may highlight only core parts of the larger process that actually contributed to the answer, the method and system of the present disclosure providing a user environment where the user may intuitively recognize the source and reliability of the information. In other words, the method and system of the present disclosure, by clearly showing the user "why this passage was selected" or "what part was reflected in the answer,” provides the user with an intuitive understanding of the basis for the model's response, thereby increasing the reliability and usability of the information.

Significantly, the method and system of the present disclosure may be effectively applied and utilized in a domain where the source or basis of the answer to the query is important. The system for generating answers based on information retrieval according to the present disclosure may be usefully applied to domains where clarity of the source and accuracy of the information in the answers are essential.

For example, in domains such as law, patents, papers, education and learning, and healthcare, the accuracy, reliability, and explicit basis of the answer to the query are crucial. In particular, in these domains, the accurate determination of the relevance of the documents used to generate the answer and accurate reporting of and proper context for the passage-specific information included within the documents are essential. More specifically, since incorrect answers based on legal documents or case law, incorrect or out of context answers citing medical papers, educational content summaries and reviews, outdated or improperly interpreted technology analyses derived from patent literature, etc., may lead to legal disputes, threats to life and safety, learning errors, distortions in technical interpretation, etc., the precise nature of the selection of documents and passages corresponding to querys and the statement of grounds for conclusions based on those documents and passages are crucial.

Therefore, the system for generating answers based on information retrieval according to the present disclosure simultaneously quantitatively may evaluate the relevant documents associated with the query and the passages included in the relevant documents, and identify and highlight the relevant passages among the passages included in the relevant document, as these serve as the basis for answer generation. By reading outputted relevant passages, users can intuitively determine the reliability of the response, and, particularly, it is possible to secure both an accurate answer based on the source information and verifiability of the model answer in the domain-based systems for generating answers based on information retrieval.

In other words, the present disclosure may be optimized for domain-specific environments where the provision of accurate and reliable information is required, making it applicable to a variety of fields, including expert systems, paper writing support, medical consultationassistance, patent analysis systems, etc.

Usefully, the methods and systems of the present disclosure can be implemented in various system environments. The present disclosure may support flexible system architecture adaptable to various execution environments, such as on-device architecture, server-client architecture, and cloud-based hybrid architecture. The system architecture may be implemented in interoperation with at least some of the components of the system for generating answers based on information retrieval illustrated in FIG. 1.

In some embodiments, the present disclosure may be implemented in the on-device environment. The model (e.g., the information retrieval model 160) and the answer generation unit 170 (e.g., the large language model) of the system for generating answers based on information retrieval may be lightweight and installed on the user terminal 10. Also, since all the query preprocessing, document retrieval, reranking, and answer generation are processed within the user terminal 10, the operation can be performed without a network connection. Accordingly, the system for generating answers based on information retrieval according to the present disclosure may operate stably even in an environment requiring personal information security or in an offline environment.

In other embodiments, the present disclosure may be implemented through the server-client architecture. The client (or client device) may collect the user query and transmit (or forward) the user query to the server, and the server 200 may perform retrieval and reranking using a large document corpus, as well as process for generating answers to queries. In this case, the server may include at least one of the document retrieval unit 150, the information retrieval model 160, and the answer generation unit 170, and the client may receive a final answer generated by the server. The server may utilize high-performance computing resources, such as a GPU or TPU, to enable more precise operations. This architecture may be flexibly selected based on user requirements, device specifications, response times, etc.

In other embodiments, the present disclosure may also be implemented in a hybrid form in which the on-device environment and the server-client architecture are combined. The methods and systems of the present disclosure may be implemented in such a structure where the query preprocessing and embedding extraction are performed on the user terminal 10, the document retrieval and re-ranking are handled by the server, and the response generation is again performed by a lightweight model within the user terminal 10. The hybrid architecture may be a flexible implementation format in which offline responsiveness, processing speed, and model accuracy may be balanced.

In other embodiments, the server may be implemented in a single-server environment, as well as a cloud-based distributed server or edge server architecture. Alternatively, the retrieval and generation model (or module) may be distributed across multiple servers and operated in a parallel processing manner. In the server architecture, the user query and result data may be encrypted and transmitted, and the personal information protection may be reinforced through methods such as anonymization/de-identification processing and authentication token-based access control.

Furthermore, considering interoperation with quantum computing environments, the present disclosure may extend to integrate qubit-based computational architecture into the on-device or server architecture, respectively, or to a hybrid computational approach with classical computing. The quantum-based extension architecture may contribute to simultaneously securing processing speed and accuracy for complex queries.

This architecture may be flexibly selected by comprehensively considering user requirements, terminal processing performance, model size, real-time requirements, response delay time, power consumption, security level, etc.

Among the various known information retrieval models, it may be confirmed that the information retrieval model 160 (e.g., "PFiD") trained using the learning method described above achieves higher recall than the conventional models because it sees richer context in document retrieval tasks, as illustrated in FIG. 10B. In other words, the information retrieval model 160 (e.g., "PFiD") according to the present disclosure may achieve competitive performance while maintaining high efficiency in both document relevance determination tasks and passage relevance determination tasks. The present results show that the information retrieval model 160 (e.g., "PFiD") according to the present disclosure performs better than the conventional models in RAG scenarios.

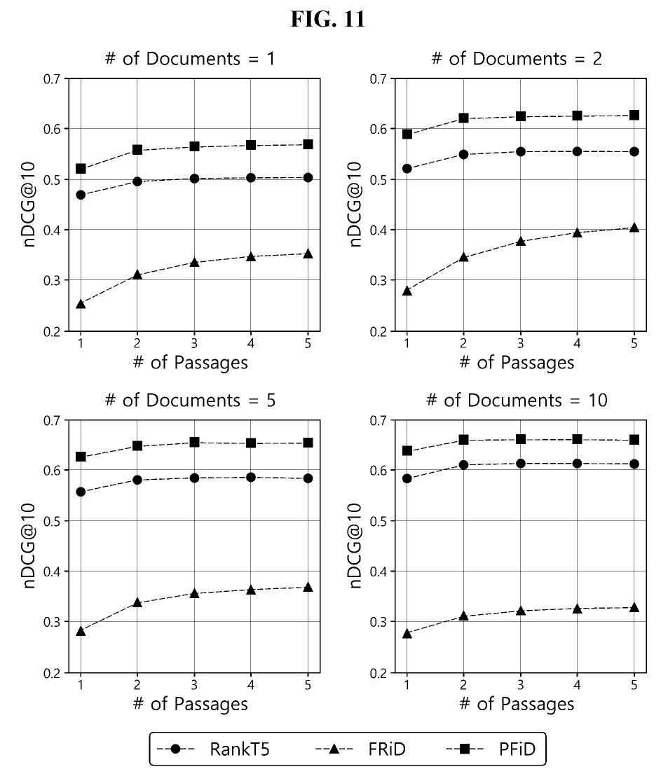

In addition, it may be confirmed that the information retrieval model 160 (e.g., “PFiD”) trained using the learning method described above maintains superior ranking performance compared to the conventional techniques even under various document and passage count conditions, as illustrated in FIG. 11. The information retrieval model 160 (e.g., “PFiD”) according to the present disclosure stably improves performance as the number of passages increases, and may secure scalability and efficiency as input increases. In other words, the information retrieval model 160 (e.g., “PFiD”) according to the present disclosure may provide accurate and sophisticated ranking results in the actual RAG environment by explicitly learning the relative similarity between the passages.

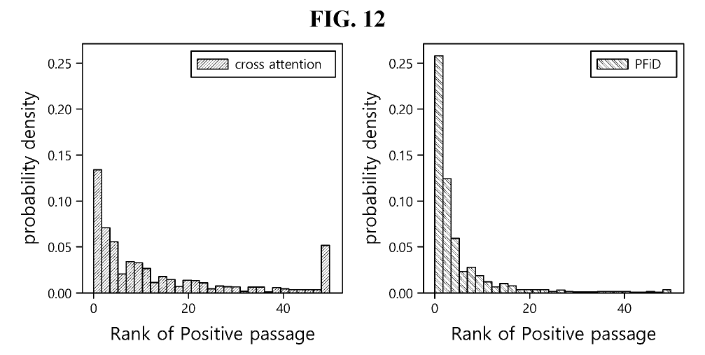

Furthermore, the information retrieval model 160 (e.g., “PFiD”) trained using the learning method described above may enable more accurate relevance determination compared to the conventional models by intensively arranging relevant passages at higher ranks, as illustrated in FIG. 12 (the left side represents the conventional model, and the right side represents the information retrieval model 160 according to the present disclosure). Through this, the present disclosure may more easily identify the ground truth passage and improve accessibility to the ground truth for the user query in the actual information retrieval scenario.

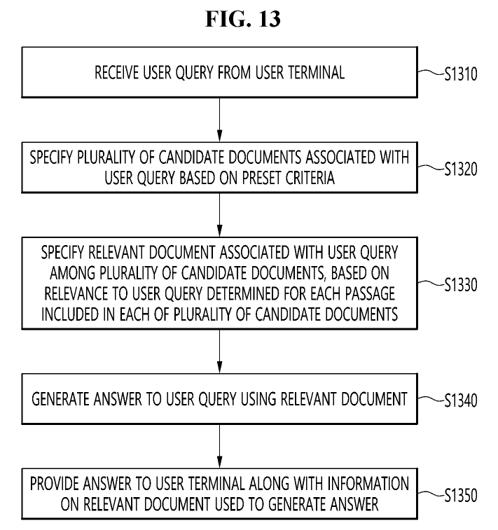

In addition, the present disclosure provides a method and system for generating answers based on information retrieval capable of providing a user-customized environment. More specifically, the system for generating answers based on information retrieval according to the present disclosure provides accurate, high-quality answers to user queries while simultaneously providing a service environment optimized for the user, and may include the information retrieval model trained according to the learning method described above. As illustrated in FIG. 13, at the inference stage, the system for generating answers based on information retrieval according to the present disclosure may allow users to intuitively recognize the information they need and understand the information more quickly through a process (S1310) of receiving a user query, a process (S1320) of specifying a plurality of candidate documents associated with a user query based on preset criteria, a process (S1330) of specifying relevant documents associated with the user query among the plurality of candidate documents based on the relevance between the user query and the plurality of candidate documents based on relevance to the user query determined for each passage included in each of the plurality of candidate documents, a process (S1340) of generating an answer to the user query using the relevant documents , and a process (S1350) of providing an answer to a user terminal along with information on the relevant document used to generate the answer.

Usefully, the service page to which the generated answer to the user query is provided may further include at least one recommended query associated with the relevant document. In this case, the method of generating the recommended query will be described in more detail later.

In this regard, in the present disclosure, receiving the user query or providing various pieces of information (e.g., answers, relevant documents, relevant passages, etc.) for the user query to the user may be performed through the service page linked to the system (or answer generation platform) for generating answers based on information retrieval or through the display unit of the user terminal 10. However, for convenience of description, the following description will be made on the assumption that the process of receiving the user query or providing various pieces of information for the user query is performed through the service page.

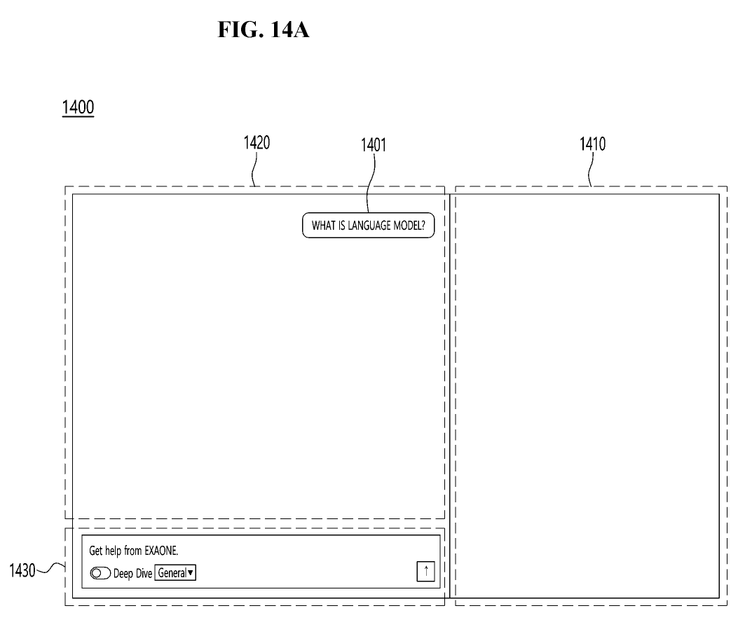

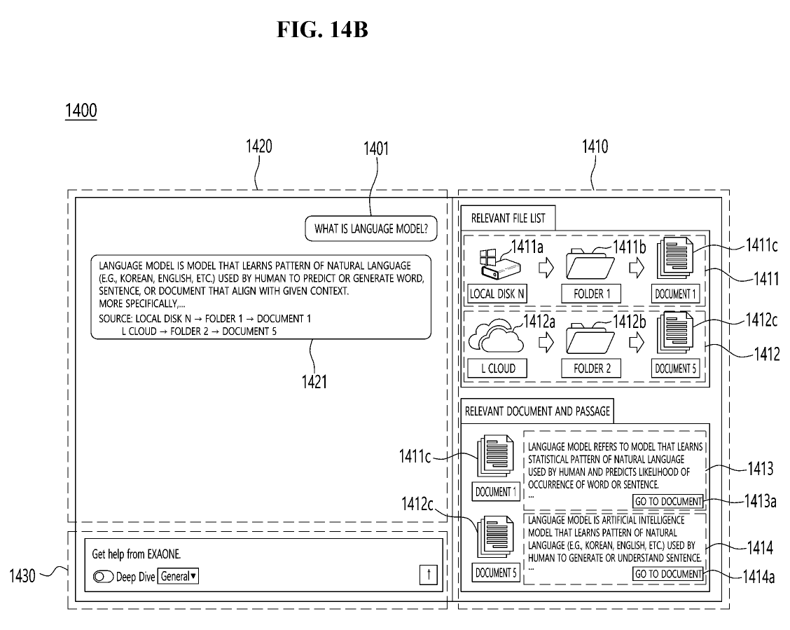

As illustrated in FIG. 14A, the control unit 180 may provide to the user terminal 10 (or output) a service page 1400 linked to the system for generating answers based on information retrieval. The service page 1400 may be configured to include a plurality of areas. For example, the service page 1400 may include at least one of a first area 1410 where information on a document and a passage are provided, a second area 1420 where an answer to a user query is provided, and a third area 1430 where the user query is received. In this case, the first area 1410 may also be named “the first area of the display unit of the user terminal 10” or “the document provision area”, etc. and the second area 1420 may also be named “the second area of the display unit of the user terminal 10” or “the answer provision area”, etc. In addition, the third area 1430 may also be named “the third area of the display unit of the user terminal 10” or “the query reception area”, etc.

The control unit 180 may receive the user query input from the user terminal 10 on which the service page 1400 is output. For example, the control unit 180 may receive a user query 1401 input through the third area 1430 of the service page 1400.

When the user query 1401 is received, the control unit 180 may specify the plurality of candidate documents associated with the user query 1401 based on the preset criteria. The control unit 180 may specify the plurality of candidate documents associated with the user query 1401 among the plurality of documents stored in a pre-specified storage. Here, the preset criterion may be associated with a retrieval criterion (e.g., BM25 score) of the document retrieval unit 150 that initially specifies (or retrieves) the candidate documents associated with the user query from the plurality of documents stored in the pre-specified storage based on the user query and/or an external server and/or website.

In some embodiments, the plurality of documents may include documents (or files) stored in the pre-specified storage (e.g., storage unit 140 (or memory), a database (DB) of the system (or platform) for generating answers based on information retrieval, a user DB linked to a user account, or a pre-configured server (e.g., server of the system for generating answers based on information retrieval), etc.).

In other embodiments, the plurality of documents may include documents (or files) stored (or built-in) in the pre-specified storage (or memory (built-in memory), storage space, database, etc.) of the user terminal 10 interoperating with the system for generating answers based on information retrieval.

In other embodiments, the system for generating answers based on information retrieval may interoperate with an external cloud storage service (e.g., LG Cloud, Google Drive, Dropbox, OneDrive, etc.) that stores the user's documents (or files). The system for generating answers based on information retrieval may store the user's document stored in the cloud storage service by linking to the user account in the pre-specified storage. In this case, the plurality of documents may include documents stored in the pre-specified storage and/or the cloud storage service.

In addition, the control unit 180 may use the information retrieval model 160 trained through the learning method described above to identify the relevant document associated with the user query 1401 among the plurality of candidate documents. The information retrieval model 160 may specify the relevant document associated with the user query 1401 among the plurality of candidate documents based on the relevance to user query 1401 determined for each passage included in the plurality of candidate documents.

Alternatively, the system for generating answers based on information retrieval may specify the relevant document associated with the user query 1401 among the plurality of candidate documents based on the history information of the user (or user account). Here, the user's history information may be associated with a user's usage history of the system (or the answer generation platform (or service)) for generating answers based on information retrieval.

The user's history information may include information associated with various events occurring in the user terminal 10 (or user account). For example, the event occurring in the user terminal 10 may include at least one of i) a user query input for obtaining an answer from the system for generating answers based on information retrieval; ii) a user document input (or selection); and iii) a new (or additional) query input for an answer generated from the system for generating answers based on information retrieval.

Based on these events, the user's history information may include at least one of i) a user query input by a user, ii) metadata (e.g., document title, author, creation date, modification date, file size, file format, language, document version, keywords, document description (or summary), etc.) about a document input by the user, iii) information (e.g., document name, document storage location, etc.) on the document input by the user, iv) content (e.g., passages included in the document, passages associated with the user query, etc.) extracted from the document input by the user, and v) an answer to a user query. However, the information included in the history information is not necessarily limited thereto, and it is understood that various pieces of other information may be further included in addition to the information described above.

Furthermore, the information retrieval model 160 may specify the relevant passage associated with the user query 1401 among the passages included in the plurality of candidate documents and used to generate an answer. In this case, the answer generation unit 170 may generate the answer to the user query 1401 using at least one of the relevant document and the relevant passage. Here, the relevant passage may also be understood as the passage included in the relevant document associated with the user query 1401.

Meanwhile, the control unit 180 may provide, to the user terminal 10, the information on the answer generated using the specific relevant document and the relevant document used to generate the answer.

The control unit 180 may provide, to the user terminal 10 on which the service page is output, the information about the answer generated using the specific relevant document and the relevant document used to generate the answer.

For example, as illustrated in FIG. 14B, the control unit 180 may provide an answer 1421 to the user query 1401 in the second area 1420 of the service page 1400 output to the user terminal 10. The answer 1421 generated for the user query 1401 may include information (e.g., “Local disk N → Folder 1→ Document 1”, “Local disk N → Folder 1 → Document 1”) on storage locations (or storage path, source, etc.) of relevant documents (e.g., “document 1” and “document 5”). In addition, the answer 1421 may include the relevant documents (e.g., “document 1” and “document 5”), and the relevant passages (e.g., “A language model is a model that learns patterns of natural languages (e.g., Korean, English, etc.) used by humans and predicts or generates words, sentences, or documents appropriate for a given context”) used to generate the answer 1421 may be highlighted.

In this case, while providing the answer 1421 to the user query, the control unit 180 may provide (or display) the information on the relevant document to the user terminal 10 such that the relevant document used to generate the answer 1421 may be confirmed (i.e., such that the user may intuitively recognize (or confirm) the relevant document). Here, the information on the relevant document may include at least one of the relevant passage, the name of the relevant document, and the storage location of the relevant document. For example, in the first area 1410 of the service page 1400 output to the user terminal 10 or a peripheral area where the answer 1421 is provided, the information on the storage locations 1411 and 1412 for each of the plurality of relevant documents (e.g., “document 1” and “document 5”) and the relevant passages 1413 and 1414 used to generate the answer 1421 among the passages included in each of the plurality of relevant documents (e.g., “document 1” and “document 5”) may be highlighted.

Alternatively, the control unit 180 may overlap, on the user terminal 10, a graphic object (or highlighting object) corresponding to a storage space (e.g., memory, disk, drive, cloud, folder, etc.) in which the relevant document is included (or stored), in association with the storage location (or storage space) of the relevant document.

For example, in the first area 1410 of the service page 1400, a graphic object 1411c corresponding to the first relevant document (e.g., “document 1”) among the plurality of relevant documents (e.g., “document 1” and “document 5”), a graphic object 1411b corresponding to a first storage space (e.g., “folder 1”) that includes the first relevant document (or where the first relevant document is located), and a graphic object 1411a corresponding to a second storage space (e.g., “local disk N”) that includes the first storage space (or where the first storage space is located) may overlap, respectively, with the corresponding document or storage space.

For another example, in the first area 1410 of the service page 1400, a graphic object 1412c corresponding to the fifth relevant document (e.g., “document 5”), a graphic object 1412b corresponding to the first storage space (e.g., “folder 2”) including the second relevant document (or where the second relevant document is located), and a graphic object 1412a corresponding to a second storage space (e.g., “L Cloud”) including the first storage space may overlap, respectively, with the corresponding document or storage space.

Furthermore, the control unit 180 may associate, on the user terminal 10, the information on the relevant passage included in the relevant document, along with the relevant document used to generate the answer 1421. In this case, the relevant passage may be provided around the relevant document, around the graphic object corresponding to the overlapped relevant document, or in the peripheral area where the answer 1421 is provided. The present disclosure does not limit the area (or space) to which such relevant passage is provided.

For example, in the first area 1410 of the service page 1400, the graphic object 1411c corresponding to the first relevant document may be overlapped with the information on the first relevant passage 1413 included in the first relevant document (e.g., “document 1”) and used to generate the answer 1421. In this case, a graphic object 1413a linked to a function that allows a user to view the first relevant document or move to the first relevant document may be provided around the graphic object 1411c corresponding to the first relevant document or associated with the first relevant document or the first relevant passage 1413.

For another example, in the first region 1410 of the service page 1400, the graphic object 1412c corresponding to the second relevant document may be associated with the information on the second relevant passage 1414 included in the second relevant document (e.g., “document 5”) and used to generate the answer 1421. In this case, a graphic object 1414a linked to a function that allows a user to view the second relevant document or move to the second relevant document may be provided around the graphic object 1412c corresponding to the second relevant document or the second relevant passage 1414.

In addition, the system for generating answers based on information retrieval according to the present disclosure may store documents (or files) utilized in the process of generating an answer to a user query. More specifically, the pre-specified storage may store at least one of the user query, the answer to the user query, the relevant document associated with the user query, and the information on the relevant document. For example, the pre-specified storage may store the user query 1401, the answer to the user query 1421, the relevant documents (e.g., “document 1” and “document 5”) associated with the user query 1401, the storage locations 1411 and 1412 of the relevant documents, and names (or document name, file name, etc.) of the relevant documents as a single set. Such information may be stored in the pre-specified storage by linking to the user account, and may also be understood as the user’s history information.

In this regard, the present disclosure may provide at least one recommended query (or a plurality of user queries, a plurality of recommended user queries, etc.) specified based on various recommendation criteria to the user terminal 10.

The control unit 180 may provide at least one query to the user terminal 10 based on preset query recommendation criteria. Here, the preset query recommendation criteria may be set based on the user's history information. For example, the preset query recommendation criteria may be associated with at least one of i) a query with a high user input frequency (i.e., question frequently asked by a user), ii) recent query of a user, iii) words or keywords (e.g., words or keywords identified from user queries, words or keywords identified as having high importance, etc.) frequently used by a user, iv) search item criteria (e.g., retrieval of documents, files, information, etc., performed by a user on the user terminal 10) of a user, v) a query with high user interest, vi) unanswered or incomplete query (e.g., query previously input by a user but not answered or stopped) and vii) cases where documents or graphic objects corresponding to documents that have been utilized as relevant documents by past user queries are provided on a service page.

When documents or graphic objects corresponding to documents that have been utilized as relevant documents by past user queries are currently provided on the service page, the past user query may be reused as the recommended query appropriate for the current situation, which may also be considered as part of the user environment information and used as input for the generative model.

At least one recommended query may be generated by the generative model for consideration by the user. In this case, the control unit 180 may process the user environment information associated with the service page as input to the generative model. The generative model may use the user environment information to generate at least one recommended query.

In this case, the environment information may include a variety of information provided to or by the user to/from the user terminal, and the control unit 180 may process various pieces of user environment information obtainable from the user terminal as input to the generative model to generate the recommended query. Here, the user environment information is used to generate criteria for the recommended query and may include at least one of the following detailed information items.

For example, the user environment information may include user action information (e.g., recent query history, document viewing/retrieval history, input patterns, clicked items, favorite content, feedback information, etc.), user interest and preference information (e.g., frequently used keywords, preferred topics, repeated viewing categories, subscription items, etc.), time and place-based information (e.g., current time, day of the week, location, schedule information, time zone-based query patterns, etc.), user terminal and service usage information (e.g., terminal type, operating system, network state, application in use, etc.), user profile information (e.g., job duties, language settings, account type, etc.), and environment information (e.g., metadata of the content currently being viewed, graphic objects being displayed, active UI components, previous recommended query acceptance/rejection history, etc.) on the service page, and such user environment information may be processed to generate information corresponding to at least one of a plurality of query recommendation criteria.

More specifically, the user action information includes user's past query activity and interaction history, and may include, for example, i) a history of a plurality of queries previously input by a user, ii) a list of documents, contents, or files viewed or retrieved by a user, iii) a user's input style or pattern (e.g., query length, writing style, expression method), iv) an item or function clicked by a user on the user terminal 10, v) a content item favorited, bookmarked, or saved by a user, vi) content (e.g., positive/negative responses, star ratings, etc.) for which the user provides feedback, vii) a frequency of user interaction with a specific function within a service page, etc.

The user interest information reflects a user's preference for specific topics or keywords based on long-term or repeated actions, and may include: i) words or keywords (e.g., words frequently extracted from past queries) frequently used by a user; ii) topics or categories repeatedly viewed by a user; iii) an area of interest estimated from user's retrieval and browsing activity; iv) a content item preferred by a user through subscriptions or notification settings; and v) a user type (e.g., technology interest type, legal information type, etc.) based on the user's long-term preference trends, etc.

The time-and location-based information reflects a user's contextual situation, and may include: i) current time information (e.g., am/pm, weekday/weekend) of the user terminal 10; ii) specific schedule information (e.g., right before a meeting, anniversary, etc.) on the day of the week or calendar; iii) current location information (e.g., work, home, public place, etc.) of a user; iv) a query pattern frequently input during a specific time zone; and v) event-based query trigger information (e.g., query occurring immediately after receiving a notification, etc.), etc.

The terminal and service state information reflects the system environment at the time of providing the recommended query, and may include: i) a type (e.g., smartphone, tablet, PC, etc.) of the user terminal; ii) operating system and software environment information (e.g., Android, iOS, Windows, etc.); iii) network environment information (e.g., Wi-Fi, 5G, local area network, etc.); iv) information on applications or browsers currently active on the user terminal; and v) service access channel (e.g., mobile apps, web browsers, etc.), etc.

The user profile information reflects user account and role-based characteristics, and may include: i) user job or role information (e.g., developer, patent attorney, administrator, etc.); ii) an account type (e.g., individual user, corporate user, administrator, etc.); iii) language settings or a UI setting value (e.g., multilingual selection, whether to use a dark mode, etc.) within a service; and iv) a user age group or permission level, etc.

The information associated with the service page reflects the content environment currently being displayed to the user, and may include i) a title, a tag, and metadata of a document, content, or graphic object currently being viewed, ii) user interface (UI) components activated within a service page, iii) a list of graphic objects currently being displayed on the service page, iv) whether a user accepts or rejects a previously provided recommended query, and v) the relevance of content provided within the service page to a past query, etc.

One or more of the above-described various types of user environment information may be combined and utilized as the preset query recommendation criteria, and the control unit 180 may process these pieces of information as input values of the generative model to generate a user-customized recommended query and provide the generated user-customized recommended query via the user terminal 10.

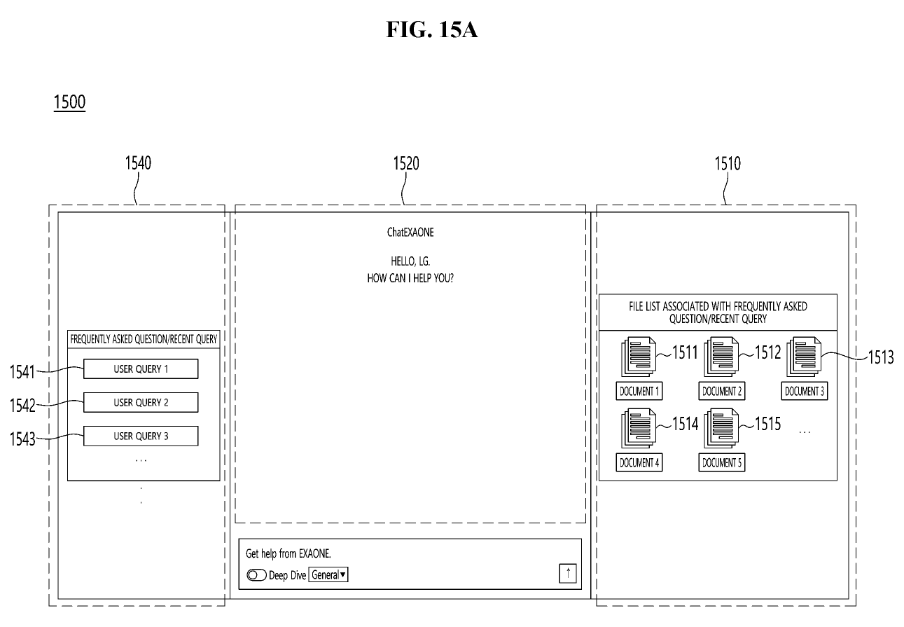

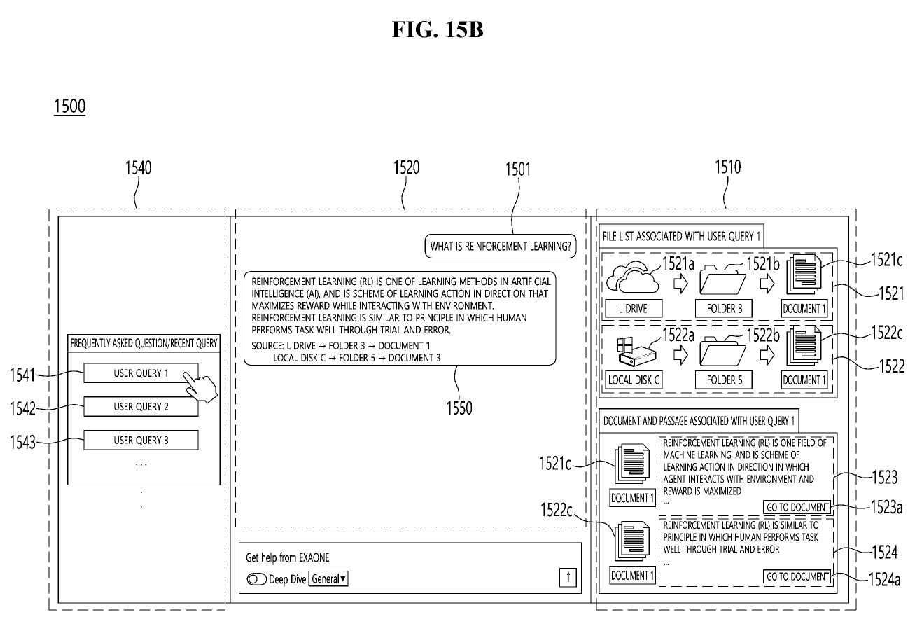

As illustrated in FIG. 15A, the control unit 180 may provide at least one recommended query (e.g., “user query 1”, “user query 2”, “user query 3”) to an area (fourth area 1540) of a service page 1500 output to the user terminal 10 based on the preset query recommendation criteria. In this case, the fourth area 1540 of the service page 1500 may also be named “fourth area of the display unit of the user terminal 10” or “recommended query provision area”, “query recommendation area”, etc.

Here, the service page may be a file explorer interface or a web browser-based interface provided on the user terminal (e.g., a smartphone or a computer (PC)). Here, the file explorer interface may also be named a “folder”. The folder is a storage unit for logically classifying and organizing a plurality of files or data items in a digital environment, and a user may group and search for related items through the folder. The “folder” is an interface unit provided within the user terminal (e.g., a smartphone, a computer, etc.), and may refer to a graphical user interface (GUI) element that logically groups and displays a plurality of contents, files, links, or service items, and provides a structure that allows the user to select or search for the plurality of contents, files, links, or service items. Furthermore, the service page is not limited to the above example, and it is sufficient if it is an interface through which a file (or document) that has been used in connection with a user query may be viewed.

Alternatively, providing at least one recommended query may also be understood as additionally associating graphic objects (or highlighting objects, 1541, 1542, and 1543) corresponding to each of the at least one recommended query (e.g., “user query 1”, “user query 2”, “user query 3”) with those recommended queries on the user terminal 10.

In this case, the control unit 180 may provide the relevant document associated with each of at least one recommended query along with the at least one recommended query to the user terminal 10. For example, the control unit 180 may provide the relevant documents (“document 1”, “document 2”, “document 3”, “document 4”, “document 5”) associated with each of the at least one recommended query (e.g., “user query 1”, “user query 2”, “user query 3”) in a first area 1510 of the service page 1500. In the first area 1510 of the service page 1500, the graphic objects (or highlighting objects, 1511, 1512, 1513, 1514, and 1515) corresponding to each of the relevant documents (“document 1”, “document 2”, “document 3”, “document 4”, “document 5”) associated with each of the graphic objects 1541, 1542, and 1543 corresponding to each of the at least one recommended query (e.g., “user query 1”, “user query 2”, “user query 3”) may each be placed in such a way that these correspondences are obvious to the user.

According to the present disclosure, each of the at least one recommended query may be configured to be displayed on the user terminal 10 in respectively different visual appearances. For example, the graphic objects 1541, 1542, and 1543, each corresponding to at least one recommended query (e.g., “user query 1”, “user query 2”, “user query 3”) and displayed adjacent to each other in the fourth area 1540 of the service page 1500, may be configured to be displayed on the user terminal 10 in respectively different visual appearances.

More specifically, the graphic object 1541 corresponding to the first recommended query (e.g., “user query 1”) among an at least one recommended query may be configured to have a first visual appearance (e.g., a first color (red)) among the respectively different visual appearances. In addition, the graphic object 1542 corresponding to the second recommended query (e.g., “user query 2”) among an at least one recommended query may be configured to have a second visual appearance (e.g., a second color (blue)), which is different from the first visual appearance. In addition, the graphic object 1543 corresponding to the third recommended query (e.g., “user query 3”) among an at least one recommended query may be configured to have a third visual appearance (e.g., a third color (yellow)) that is different from the first and second visual appearances.

In this case, in the methods and systems illustrated in the present disclosure, the relevant documents associated with each of the at least one recommended query may be configured to be displayed on the user terminal 10 in the same visual appearance as displayed by the corresponding at least one recommended query such that relevance of each relevant document to the corresponding at least one recommended query can be identified. The first recommended query (e.g., “user query 1”) and the relevant documents (e.g., “document 1” and “document 3”) associated with the first recommended query may be displayed on the user terminal 10 in the first visual appearance, the second recommended query (e.g., “user query 2”), and the relevant documents (e.g., “document 2” and “document 4”) associated with the second recommended query may be displayed on the user terminal 10 in the second visual appearance, and the third recommended query (e.g., “user query 3”) and the relevant documents (e.g., “document 5”) associated with the third recommended query may be displayed on the user terminal 10 in the third visual appearance.

In some embodiments, the graphic object 1511 corresponding to the first relevant document (e.g., “document 1”) associated with the first recommended query (e.g., “user query 1”) having the first visual appearance and the graphic object 1513 corresponding to the third relevant document (e.g., “document 3”), also associated with the first recommended query, may each appear in the first area 1510 in the same first visual appearance as the visual appearance of the first recommended query.

In other embodiments, the graphic object 1512 corresponding to the second relevant document (e.g., “document 2”) associated with the second recommended query (e.g., “user query 2”) among an at least one recommended query and having the second visual appearance and the graphic object 1514 corresponding to the fourth relevant document (e.g., “document 4”) may each be displayed in the first area 1510 in the same second visual appearance as the visual appearance of the second recommended query.

In other embodiments, the graphic object 1515 corresponding to the fifth relevant document (e.g., “document 5”) associated with the third recommended query (e.g., “user query 3”) among an at least one recommended query and having the third visual appearance may be displayed in the first area 1510 in the same third visual appearance as the visual appearance of the third recommended query.

Furthermore, when a specific recommended query of any one of an at least one recommended query is selected from the user terminal 10, the control unit 180 may provide the user terminal 10 with an answer to the specific recommended query, along with information on the specific relevant document among the relevant documents associated with each of the at least one recommended query that was used to generate the answer to the selected specific recommended query.

As described above, the pre-specified storage may store the user query, the answer to the user query, the relevant document associated with the user query, and the information on the relevant document as a single set. Accordingly, the pre-specified storage may store and have a plurality of sets, each including the user query, the answer to the user query, the relevant document associated with the user query, and the information on the relevant document.

The control unit 180 may, based on the selection of the specific recommended query of any one of an at least one specific recommended query from the user terminal 10, specify the specific set associated with (or including) the selected specific recommended query among the plurality of sets stored in the pre-specified storage. The control unit 180 may provide the user terminal 10 with the information on the answer to the specific recommended query included in the specific set and the specific relevant document used to generate the answer to the specific recommended query. Alternatively, the control unit 180 may provide the user terminal 10 with the answer to the specific recommended query included in (or linked to, associated with, interoperating with, etc.) the specific recommended query and the information on the specific relevant document used to generate the answer to the specific recommended query, based on selection of the specific recommended query of any one of an at least one specific recommended query from the user terminal 10. Here, the information on the specific relevant document is associated with the specific recommended query and includes information from passages included in the specific relevant document, and may include at least one of the specific relevant passage used to generate the answer to the specific recommended query, the name of the specific relevant document, and the storage location of the specific relevant document.

For example, as illustrated in FIG. 15B, the control unit 180 may provide in the second area 1520 of the service page 1500 output to the user terminal 10 an answer 1550 to the first recommended query included in the graphic object 1541 corresponding to the first recommended query, the answer 1550 being based on the selection of the graphic object 1541 corresponding to the first recommended query (e.g., “What is reinforcement learning”?) from among the graphic objects 1541, 1542, and 1543 corresponding to each of the at least one recommended query (e.g., “user query 1”, “user query 2”, “user query 3”) shown on the user terminal 10. This answer 1550 may include information on the storage locations of the relevant documents (e.g., “document 1” and “document 3”) (e.g., “L drive → folder 3 → document 1”, “local disk C → folder 5 → document 3”). In addition, the answer 1550 includes the relevant documents (e.g., “document 1” and “document 3”), and the relevant passage (e.g., “reinforcement learning (RL) is one of the artificial intelligence (AI) learning methods, and a method of learning actions in a direction that maximizes a reward while interacting with the environment”) used to generate the answer 1550 may be highlighted.

In this case, while providing the answer 1550 for the specific recommended query selected by the user, the control unit 180 may display the information on the specific relevant document on the user terminal 10 such that the user may confirm the specific relevant document used to generate the answer 1550 for the specific recommended query. For example, in the first area 1510 of the service page 1500 output to the user terminal 10 or the peripheral area where the answer 1550 is provided, the information on the storage locations 1521 and 1522 for each of the plurality of specific relevant documents (e.g., “document 1” and “document 3”) and the relevant passages 1523 and 1524 used to generate the answer 1550 among the passages included in each of the plurality of specific relevant documents (e.g., “document 1” and “document 3”) may be highlighted.

Alternatively, the control unit 180 may associate, on the user terminal 10, the graphic object (or highlighting object) corresponding to the storage space (e.g., memory, disk, drive, cloud, folder, etc.) including (or storing) the specific relevant document, with the storage location (or storage space) of the specific relevant document used to generate the answer 1550 for the specific recommended query.

In an embodiment, in the first area 1510 of the service page 1500, a graphic object 1521c corresponding to the first specific relevant document (e.g., “document 1”) among the plurality of specific relevant documents (e.g., “document 1” and “document 3”), a graphic object 1521b corresponding to the first storage space (e.g., “folder 3”) (or where the first specific relevant document is located) that includes the first specific relevant document, and a graphic object 1521a corresponding to the second storage space (e.g., “L drive”) (or where the first storage space is located) that includes the first storage space may each be displayed.

In another embodiment, in the first area 1510 of the service page 1500, a graphic object 1522c corresponding to the third specific relevant document (e.g., “document 3”), a graphic object 1522b corresponding to the first storage space (e.g., “folder 5”) (or where the third specific relevant document is located) including the third specific relevant document, and a graphic object 1522a corresponding to a second storage space (e.g., “Local Disk C”) including the first storage space may each be displayed.

Furthermore, the control unit 180 may display, on the user terminal 10, the information on the specific relevant passage included in the specific relevant document, along with the specific relevant document used to generate the answer 1550 to the specific recommended query. In this case, the specific relevant passage may be provided near the specific relevant document, near the graphic object corresponding to the overlapped specific relevant document, or in an area where the answer 1550 is provided. The present disclosure does not limit the area (or space) in which the specific relevant passage is provided to any one area.

For example, in the first area 1510 of the service page 1500, the graphic object 1521c corresponding to the first specific relevant document may be displayed along with information on the specific relevant passage 1523 included in the first specific relevant document (e.g., “document 1") and used to generate the answer 1550. In this case, a graphic object 1523a linked to a function that allows a user to view the first specific relevant document or move to the first specific relevant document may be provided near the graphic object 1521c corresponding to the first specific relevant document, or the specific relevant passage 1523.

For another example, in the first area 1510 of the service page 1500, the graphic object 1522c corresponding to the third specific relevant document may be displayed, along with information on the specific relevant passage 1524 that was included in the third specific relevant document (e.g., “document 3") and used to generate the answer 1550. In this case, a graphic object 1524a that is linked to a function that allows a user to view the third specific relevant document or move to the third specific relevant document may be provided near the graphic object 1522c corresponding to the third specific relevant document, or the specific relevant passage 1524.

In another embodiment of the present disclosure, the present disclosure may provide the user terminal 10 with a plurality of respectively different keyword-specific queries (or keyword-specific recommended queries) based on the preset query recommendation criteria.

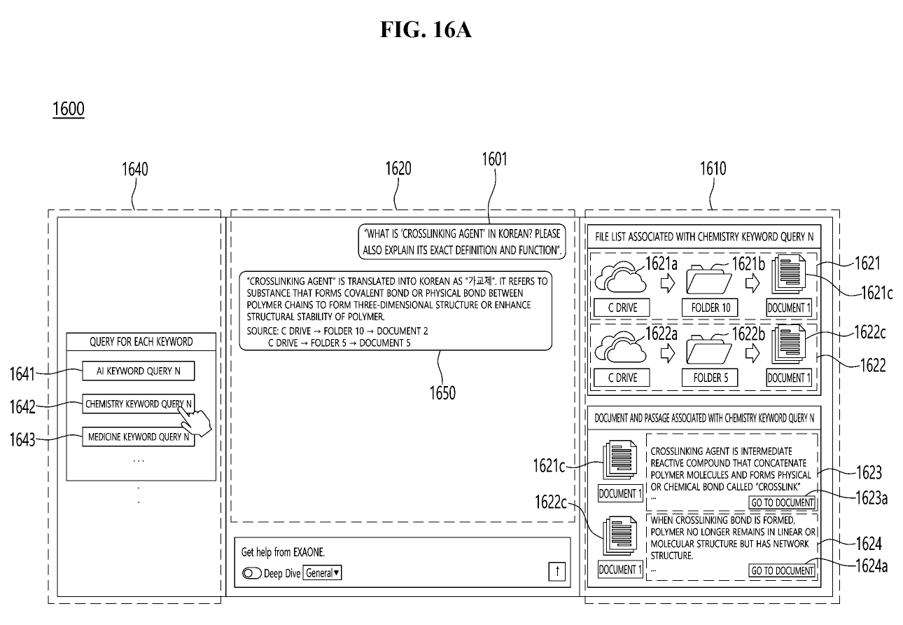

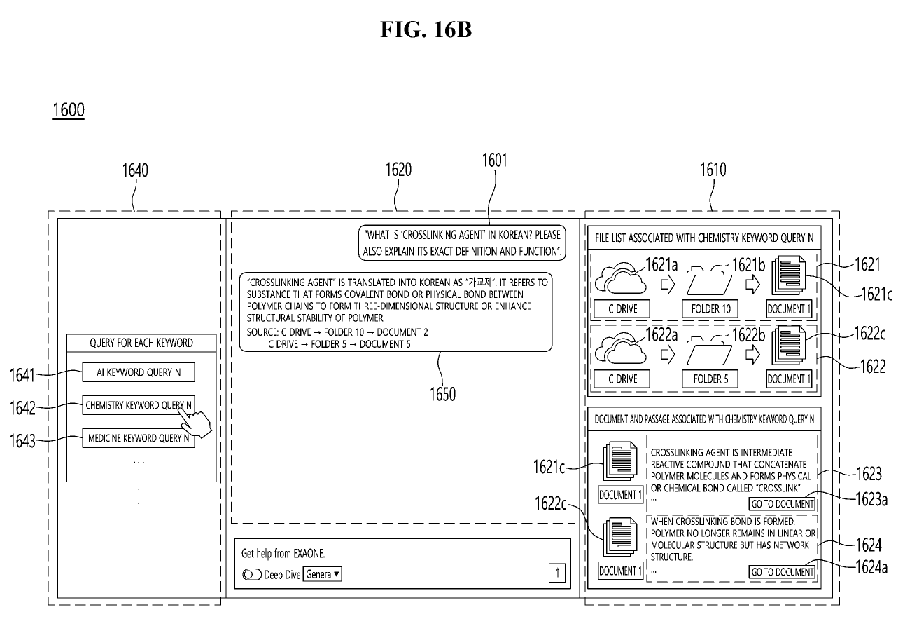

For example, as illustrated in FIG. 16A, the control unit 180 may provide the keyword-specific recommended query (e.g., “AI keyword query N”, “chemistry keyword query N”, “medical keyword query N”) to an area (the fourth area 1640) of a service page 1600 output to the user terminal 10 based on the preset query recommendation criteria.

Alternatively, providing the keyword-specific recommended query may also be understood as corresponding to the graphic object (or highlighting objects 1641, 1642, and 1643) corresponding to each of the keyword-specific recommended queries (e.g., “AI keyword query N”, “chemistry keyword query N”, “medical keyword query N”) on the user terminal 10.

In this case, the control unit 180 may provide the user terminal 10 with the relevant documents associated with each of the keyword-specific recommended queries, along with the keyword-specific recommended queries. For example, the control unit 180 may provide the relevant documents (“document 1”, “document 2”, “document 3”, “document 4”, “document 5”) associated with each of the keyword-specific recommended queries (e.g., “AI keyword query N”, “chemistry keyword query N”, “medical keyword query N”) in a first area 1610 of the service page 1600. In the first area 1610 of the service page 1600, graphic objects (or highlighting objects, 1611, 1612, 1613, 1614, and 1615) corresponding to each of the relevant documents (“document 1”, “document 2”, “document 3”, “document 4”, “document 5”) associated with each of the graphic objects 1641, 1642, and 1643 corresponding to each of the keyword-specific recommended queries (e.g., “AI keyword query N”, “chemistry keyword query N”, “medical keyword query N”) may each be overlapped.

In the present disclosure, each of the keyword-specific recommended queries may be configured to be displayed on the user terminal 10 in the respectively different visual appearances. For example, graphic objects 1641, 1642, and 1643 corresponding to each of the keyword-specific recommended queries (e.g., “AI keyword query N”, “chemistry keyword query N”, “medical keyword query N”) displayed in the fourth area 1640 of the service page 1600 may be configured to be displayed on the user terminal 10 in the respectively different visual appearances.

More specifically, the graphic object 1641 corresponding to the recommended query (e.g., “AI keyword query N”) for the first keyword among the keyword-specific recommended queries may be configured to have the first visual appearance (e.g., the first color (red)) among the respectively different visual appearances. In addition, the graphic object 1642 corresponding to the recommended query (e.g., “chemistry keyword query N”) for the second keyword among the keyword-specific recommended queries may be configured to have the second visual appearance (e.g., a second color (blue)), which is different from the first visual appearance. In addition, the graphic object 1643 corresponding to a recommended query (e.g., “medical keyword query N”) for a third keyword among the keyword-specific recommended queries may be configured to have a third visual appearance (e.g., a third color (yellow)), which is different from the first and second visual appearances.

In this case, in the present disclosure, the relevant documents associated with each of the keyword-specific recommended queries may be configured to be displayed on the user terminal 10 in the visual appearance corresponding to the associated keyword-specific recommended query such that the relevance of each document to one or more keyword-specific recommended queries can be identified. The recommended query for the first keyword (e.g., “AI keyword query N”) and the relevant documents associated with the recommended query for the first keyword (e.g., “document 1” and “document 4”) may be displayed on the user terminal 10 in the first visual appearance, and the recommended query for the second keyword (e.g., “chemistry keyword query N”) and the relevant documents (e.g., “document 2” and “document 4”) associated with the recommended query for the second keyword may be displayed on the user terminal 10 in the second visual appearance, and the recommended query for the third keyword (e.g., “medical keyword query N”) and the relevant document (e.g., “document 5”) associated with the recommended query for the third keyword may be displayed on the user terminal 10 in the third visual appearance.

In some embodiments, the graphic object 1611 corresponding to the first relevant document (e.g., “document 1”) associated with the recommended query (e.g., “AI keyword query N”) for the first keyword having the first visual appearance among the keyword-specific recommended queries and the graphic object 1614 corresponding to the fourth relevant document (e.g., “document 4”) may each be displayed in the first area 1610 in the same first visual appearance as the visual appearance of the recommended query for the first keyword.

In other embodiments, the graphic object 1612 corresponding to the second relevant document (e.g., “document 2”) associated with the recommended query (e.g., “chemistry keyword query N”) for the second keyword having the second visual appearance among the keyword-specific recommended queries, and the graphic object 1615 corresponding to the fifth relevant document (e.g., “document 5”) may each be displayed in the first area 1610 in the same second visual appearance as the visual appearance of the recommended query for the second keyword.

In still another embodiment, the graphic object 1613 corresponding to the third relevant document (e.g., “document 3”) associated with the recommended query (e.g., “medical keyword query N”) for the third keyword having the third visual appearance among the keyword-specific recommended queries may be displayed in the first area 1610 in the third visual appearance of the recommended query for the third keyword.

Furthermore, when the recommended query (or a recommended query associated with a specific keyword) for a specific keyword of any one of the keyword-specific recommended queries is selected from the user terminal 10, the control unit 180 may provide the user terminal 10 with the answer, along with information on the specific relevant document used to generate the answer to the recommended query for the selected specific keyword, among relevant documents associated with each of the keyword-specific recommended queries.

Based on the selection of the recommended query for the specific keyword of any one of the keyword-specific recommended queries from the user terminal 10, the control unit 180 may specify the specific set associated with the recommended query for the selected specific keyword (or including the recommended query for the specific keyword) from among the plurality of sets stored in the pre-specified storage. The control unit 180 may provide the user terminal 10 with the answer to the recommended query for the specific keyword included in the specific set and information on the specific relevant document used to generate the answer. Alternatively, based on the selection of the recommended query for the specific keyword of any one of the keyword-specific recommended queries from the user terminal 10, the control unit 180 may provide the user terminal 10 with the information on the answer to the recommended query included in (or linked, associated, interoperating with, etc.) the recommended query and the specific relevant document used to generate the answer.

For example, as illustrated in FIG. 16B, the control unit 180 may provide the answer 1650 to the recommended query for the second keyword included in the graphic object 1642 corresponding to the recommended query for the second keyword (e.g., “What is crosslinking agent in Korean? Please explain the exact definition and function as well”.) in the second area 1620 of the service page 1600 output to the user terminal 10 based on the selection of the graphic object 1642 corresponding to the recommended query for the second keyword among the graphic objects 1641, 1642, and 1643 corresponding to each of the keyword-specific recommended queries (e.g., “AI keyword query N”, “Chemical keyword query N”, “Medical keyword query N”) from the user terminal 10. The answers 1650 may include information on the storage locations of relevant documents (e.g., “document 2” and “document 5”) (e.g., “C Drive → Folder 10 → Document 2”, “C Drive → Folder 5 → Document 5”). Furthermore, in the answer 1650, the relevant passages (e.g., “Crosslinking agent” can be translated into Korean and refers to a substance that forms covalent or physical bonds between polymer chains, thereby forming a three-dimensional structure of the polymer or enhancing its structural stability) included in the relevant document (e.g., “document 2” and “document 5”) and used to generate the answer 1650 may be highlighted.

In this case, while providing the answer 1650 for the recommended query based on the specific keyword selected by the user, the control unit 180 may display the information on the specific relevant document on the user terminal 10 such that the user may confirm the specific relevant document used to generate the answer 1650. For example, in the first area 1610 of the service page 1600 output to the user terminal 10 or the peripheral area where the answer 1650 is provided, the information on the storage locations 1621 and 1622 for each of the plurality of specific relevant documents (e.g., “document 1” and “document 5”) and the relevant passages 1623 and 1624 used to generate the answer 1650 among the passages included in the plurality of specific relevant documents (e.g., “document 2” and “document 4”) may be highlighted.

Alternatively, the control unit 180 may associate, on the user terminal 10, the graphic object (or highlighting object) corresponding to the storage space (e.g., memory, disk, drive, cloud, folder, etc.) including (or storing) the specific relevant document with the storage location (or storage space) of the specific relevant document used to generate the answer 1650 for the recommended query for the specific keyword.

For example, in the first area 1610 of the service page 1600, a graphic object 1621c corresponding to the second specific relevant document (e.g., “document 2”) among the plurality of specific relevant documents (e.g., “document 2” and “document 4”), a graphic object 1621b corresponding to the first storage space (e.g., “folder 10”) that includes the second specific relevant document (or where the second specific relevant document is located), and a graphic object 1621a corresponding to the second storage space (e.g., “C drive”) that includes the first storage space (or where the first storage space is located) may each be displayed in close proximity to each other.

For another example, in the first area 1610 of the service page 1600, a graphic object 1622c corresponding to the fourth specific relevant document (e.g., “document 4”), a graphic object 1622b corresponding to the first storage space (e.g., “folder 5”) including the fourth specific relevant document (or where the fourth specific relevant document is located), and a graphic object 1622a corresponding to the second storage space (e.g., “C drive”) including the first storage space may each be displayed in close proximity to each other.

Furthermore, the control unit 180 may display, on the user terminal 10, the information on the specific relevant passage included in the specific relevant document, along with the specific relevant document used to generate the answer 1650 to the recommended query associated with the specific keyword. In this case, the specific relevant passage may be displayed near the specific relevant document, near the graphic object corresponding to the displayed specific relevant document, or in a peripheral area where the answer 1650 is provided. The present disclosure does not limit the area (or space) to which the specific relevant passage is provided.

For example, in the first area 1610 of the service page 1600, the graphic object 1621c corresponding to the second specific relevant document may be displayed along with information on the specific relevant passage 1623 included in the second specific relevant document (e.g., “document 2") and used to generate the answer 1650. In this case, a graphic object 1623a linked to a function that allows a user to view the second specific relevant document or move to the second specific relevant document may be displayed near the graphic object 1621c corresponding to the second specific relevant document or the displayed second specific relevant document, or the specific relevant passage 1623.

For another example, in the first area 1610 of the service page 1600, the graphic object 1622c corresponding to the fifth specific relevant document may be displayed along with information on the specific relevant passage 1624 included in the fifth specific relevant document (e.g., “document 5") and used to generate the answer 1650. In this case, a graphic object 1624a linked to a function that allows a user to view the fifth specific relevant document or move to the fifth specific relevant document may be displayed near the graphic object 1622c corresponding to the fifth specific relevant document or the displayed fifth specific relevant document, or the specific relevant passage 1624.

Methods and systems of the present disclosure may provide the plurality of recommended documents specified according to various document recommendation criteria to the user terminal 10. The control unit 180 may provide the plurality of recommended documents to the user terminal 10 based on preset document recommendation criteria. Here, the preset document recommendation criteria may be set based on the user's history information. For example, the preset document recommendation criteria may include at least one of i) a document (i.e., documents frequently used by a user) with a high user usage frequency, ii) documents recently used by the user, iii) search item criteria (e.g., retrieval of documents, files, information, etc., performed by a user on the user terminal 10) of a user, and iv) documents with a high user interest.

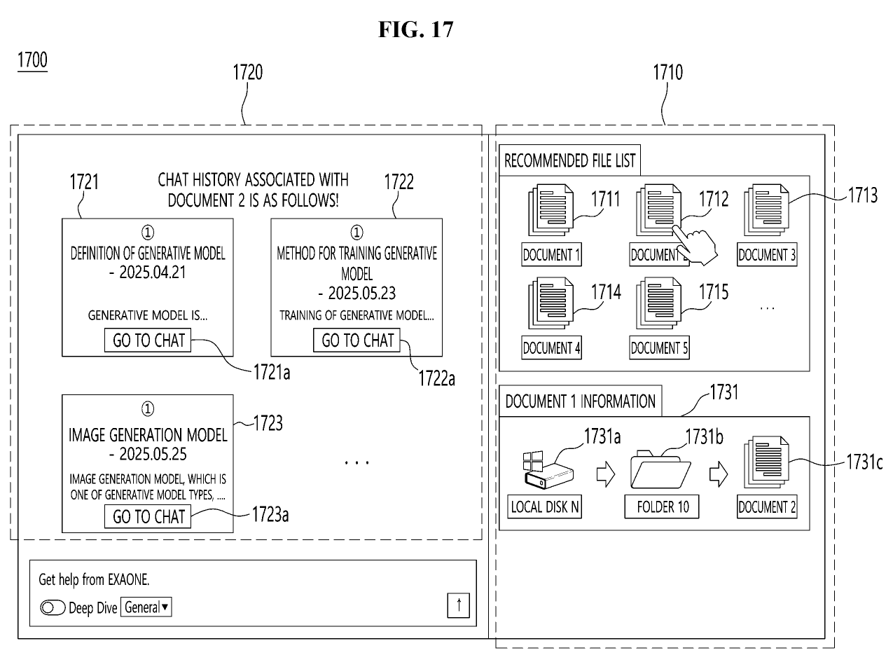

For example, as illustrated in FIG. 17, the control unit 180 may provide the plurality of recommended documents (e.g., “document 1”, “document 2”, “document 3”, “document 4”, “document 5”) in one area (the first area 1710) of the service page 1700 output to the user terminal 10 based on the preset document recommendation criteria. Alternatively, providing the plurality of recommended documents may also be understood as displaying, on the user terminal 10, graphic objects (or highlighting objects, 1711, 1712, 1713, 1714, and 1715) corresponding to each of the plurality of recommended documents (e.g., “document 1”, “document 2”, “document 3”, “document 4”, “document 5”).

The control unit 180 may provide at least one of the chat history information associated with each of the plurality of recommended documents and information on each of the plurality of recommended documents to the user terminal. When one of the plurality of recommended documents is selected from the user terminal 10, the control unit 180 may provide at least one of the chat history information associated with the selected specific recommended document and information on the specific recommended document. The chat history information may include at least one of the user query associated with each of the plurality of recommended documents, the answer generated using each of the plurality of recommended documents, and the relevant passage used to generate the answer for each of the plurality of recommended documents.

For example, the control unit 180 may provide the chat history information 1721, 1722, and 1723 included in (or linked, associated, interoperating with, etc.) the selected graphic object to the second area 1720 of the service page 1700 based on the selection of the graphic object 1712 corresponding to the second recommended document (e.g., “document 2”) among the graphic objects 1711, 1712, 1713, 1714, and 1715 corresponding to each of the plurality of recommended documents (e.g., “document 1”, “document 2”, “document 3”, “document 4”, “document 5”) provided in the first area 1710 of the service page 1700 from the user terminal 10. In this case, in one area of the service page 1000 where the chat history 1721, 1722, and 1723 is provided or in the surrounding area where the chat history 1721, 1722, and 1723 is provided, graphic objects 1721a, 1722a, and 1723a linked to a function that allows the user to view the corresponding chat or move to the corresponding chat may be provided.

In addition, the control unit 180 may display information on the selected specific recommended documents on the user terminal 10. For example, in the first area 1710 of the service page 1700 output to the user terminal 10 or the surrounding area of the specific recommended document, the information on the storage location 1731 for specific recommended documents (e.g., “document 2”) may be highlighted.

Alternatively, the control unit 180 may display upon the user terminal 10 the graphic object (or highlighting object) corresponding to the storage space (e.g., memory, disk, drive, cloud, folder, etc.) where the specific recommended documents are included (or stored), in association with the storage location (or storage space) of the specific recommended document.

For example, in the first area 1710 of the service page 1700, a graphic object 1731c corresponding to the second specific recommended document (e.g., “document 2”), a graphic object 1731b corresponding to the first storage space (e.g., “folder 10”) that includes the second specific recommended document (or where the second specific recommended documents are located), and the graphic objects 1731a corresponding to the second storage space (e.g., “local disk N”) that includes the first storage space (or where first storage space is located) may each be displayed.

As described above, according to the method and system for generating answers based on information retrieval according to the present disclosure, by constructing input data as pairs of queries and passages included in candidate documents and independently encoding the input data to generate semantic representations, it is possible to process a large amount of input documents in parallel. That is, according to the present disclosure, by encoding the plurality of passages within the input documents in parallel without separate sequential processing, it is possible to optimize the semantic representations between the passages, increase the input processing speed of the system, and ensure real-time responsiveness to the large data sets.

In addition, according to the method and system for generating answers based on information retrieval according to the present disclosure, by integrating the encoded semantic representations and predicting the relevance between the query and the entire document through the relevance word token using the integrated semantic representations, it is possible to accurately determine the relevance of the entire document. Through this, according to the present disclosure, it is possible to perform the accurate document-level ranking that reflects the integrated meaning of the plurality of passages and improve the document retrieval performance compared to conventional information retrieval systems.

Furthermore, according to the method and system for generating answers based on information retrieval according to the present disclosure, by applying the inter-passage attention mechanism to the encoded semantic expressions to train the relative similarity between the passages, it is possible to distinguish the semantic differences between the plurality of passages and improve the accuracy and consistency of the passage-level ranking.

In addition, according to the method and system for generating answers based on information retrieval according to the present disclosure, by training the model to simultaneously perform the document reranking and the passage extraction necessary for the answer generation, it is possible to ensure balanced quality between the document ranking and the passage ranking. By doing this, it is possible to achieve highly reliable ranking results at both the document level and the passage level and to maintain consistent performance in various retrieval and response generation systems.

Furthermore, according to the method and system for generating answers based on information retrieval according to the present disclosure, it is possible to train the model to simultaneously determine the relevance between the query and the entire document and the relevance between the query and each of the plurality of passages. In other words, according to the present disclosure, by simultaneously ranking the documents and the passages, it is possible to reduce the influence of noisy context in the externally retrieved information and improve the accuracy and reliability of the large language model (LLM) responses generated based on this. It is possible to enable quick and stable retrieval and response processing even in the real-time retrieval augmented generation (RAG) system environment where large information retrieval occurs, prevent the errors that may occur in the LLM responses, and enhance user reliability.

In addition, according to the method and system for generating answers based on information retrieval according to the present disclosure, it is possible to reduce unnecessary computation and optimize computational resource usage through a multi-granularity ranking structure via a single inference path. Through this, it is possible to reduce server infrastructure costs and improve the operational efficiency of a large AI search system.

In addition, according to the method and system for generating answers based on information retrieval according to the present disclosure, by providing information on the relevant documents associated with the user query along with answers generated using those relevant documents, it is possible to cause users to intuitively recognize and more quickly understand the information they need.

Furthermore, according to the method and system for generating answers based on information retrieval according to the present disclosure, by visually providing information on the documents utilized in the answer generation process, it is possible to cause users to intuitively confirm the source and reliability of the answer, quickly and accurately obtain the information they need and maximize the efficiency of the search for the relevant documents.

In addition, according to the method and system for generating answers based on information retrieval according to the present disclosure, it is possible to select the relevant documents associated with the user queries based on user history information and provide answers to the user queries based on the selected documents. In other words, by providing customized information to the users by reflecting their preferences, interests, and LLM usage patterns, etc., it is possible to significantly improve the personalized performance of the answer generation service as well as the quality of interaction with the users.

For improved parallel processing, the present disclosure described above may be implemented using a quantum computer. A useful plan for implementing methods and systems of the present disclosure based on the quantum computer may include use of a qubit-based quantum processor and quantum memory as well as software and hardware interfaces optimized for quantum computing.

The quantum processor of a quantum computer utilizes qubits to efficiently perform complex computations through parallel processing, quantum entanglement, and quantum superposition, etc., and this cannot be achieved using the binary bits of classical computers. The quantum processor processes data using quantum gates and may provide exponential speedups for specific problems.

As described above, the methods and systems of the present disclosure may be implemented as a program that is executed by one or more processes on a computer and stored on a computer-readable medium (or recording medium).

Furthermore, as described above, the methods and systems of the present disclosure may be implemented as computer-readable codes or instructions on a medium recording a program. In other words, the methods and systems of the present disclosure may be provided in the form of a program.

The computer readable medium may include all kinds of recording devices in which computer system-readable data is stored. An example of the computer readable-medium may include a hard disk drive (HDD), a solid state disk (SSD), a silicon disk drive (SDD), a read-only memory (ROM), a random access memory (RAM), a compact disk read-only memory (CD-ROM), a magnetic tape, a floppy disk, an optical data storage, and the like.

Furthermore, the computer-readable medium may be a server or cloud storage that includes storage and may be accessed by the electronic device via communication. In this case, the computer may download the program prepared according to the present disclosure from the server or cloud storage via wired or wireless communication.

The computer program may reach the system for generating answers based on information retrieval of the present disclosure through various suitable transmission mechanisms. The transmission mechanism may be, for example, a computer-readable storage medium, a computer program product, a memory device, a recording medium such as a CD-ROM or DVD, or a product tangibly embodying a computer program. The transmission mechanism may be a signal configured to stably transmit a computer program over air or through an electrical connection. The system for generating answers based on information retrieval of the present disclosure may propagate or transmit the computer program as a computer data signal.

Furthermore, references to "computer-readable storage medium”, "computer program product”, "computer program tangibly embodied”, or the like, or "controller”, "computer”, or "processor”, or the like should be understood to encompass not only computers with various architectures, such as single/multiprocessor architectures and sequential (Von Neumann)/parallel architectures, but also specialized circuits, such as a field-programmable gate array (FPGA), an application-specific circuit (ASIC), a signal processing device, and other devices. References to computer programs, instructions, codes, or the like, shall be understood as including instructions for processors or software for programmable processors or firmware, such as configuration settings for a fixed-function device, a gate array, or a programmable logic device, or any programmable content for a hardware device.

Furthermore, in the present disclosure, the computer described above is an electronic device equipped with a processor, i.e., a central processing unit (CPU), and there are no particular limitations on its type.

Although certain embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A computerized method for generating answers based on information retrieval, comprising:
receiving a user query from a user terminal;
specifying a plurality of candidate documents associated with the user query based on presetcriteria, each candidate document including at least one passage;
determining relevance to the user query on a passage-by-passage basis for each passage included in at least one of the plurality of candidate documents;
specifying a relevant document associated with the user query among the plurality of candidate documents based on the relevance to the user query determined for each passage included in the plurality of candidate documents; and
generating an answer to the user query using the relevant document, wherein the answer is provided to the user terminal

2. The computerized method for generating answers of claim 1, further comprising:
configuring input data such that the user query and a specific passage among the passages included in the plurality of candidate documents form a pair; and
processing the input data as input to an encoder to specify the relevant document associated with the user query among the plurality of candidate documents,
wherein the determining of the relevance to the user query includes determining the relevance to the user query for each passage included in the plurality of candidate documents using an embedding vector corresponding to the input data acquired from the encoder.

3. The computerized method for generating answers of claim 2, wherein when the specific passages are plural, the input data includes a plurality of specific passages.

4. The computerized method for generating answers of claim 2, wherein the encoder performs an interaction between the user query and the specific passages included in the input data to acquire the embedding vector corresponding to the input data.

5. The computerized method for generating answers of claim 3, wherein when the input data includes the plurality of specific passages, the plurality of embedding vectors corresponding to the input data are acquired from the encoder.

6. The computerized method for generating answers of claim 5, wherein the input data includes the plurality of specific passages, wherein the determining of the relevance to the user query includes:
combining the plurality of embedding vectors into one to generate a combined embedding vector;
processing the combined embedding vector as input to a decoder; and
determining a relevance to the user query for each of the plurality of candidate documents using the combined embedding vector in the decoder.

7. The computerized method for generating answers of claim 6, wherein the combined embedding vector represents overall semantic relevance between the user query and passages included in the plurality of candidate documents.

8. The computerized method for generating answers of claim 6, wherein the decoder generates a relevance word token for each of the plurality of candidate documents based on the relevance determined using the combined embedding vector.

9. The computerized method for generating answers of claim 8, wherein the relevance word token displays a word token state representing whether the user query and the corresponding document have relevance to each other, and
is configured to display a first relevance word token if the user query and the corresponding document are relevant to each other or a second relevance word token if the user query and the corresponding document are not relevant to each other.

10. The computerized method for generating answers of claim 8, wherein the decoder is configured to predict the relevance word token state for each of the plurality of candidate documents.

11. The computerized method for generating answers of claim 9, wherein a document including the first relevance word token among the plurality of candidate documents is specified as the relevant document associated with the user query.

12. The computerized method for generating answers of claim 2, wherein when the input data includes the plurality of specific passages, the plurality of embedding vectors corresponding to the input data are acquired from the encoder, and
the determining of the relevance to the user query includes:
processing the plurality of embedding vectors as input to a ranker layer; and
determining the relevance to the user query for each passage included in the plurality of candidate documents using the plurality of embedding vectors in the ranker layer.

13. The computerized method for generating answers of claim 12, wherein the ranker layer generates a passage relevance score for each passage included in the plurality of candidate documents based on the relevance determined using the plurality of embedding vectors.

14. The computerized method for generating answers of claim 13, wherein the passage relevance score is a score representing whether there is relevance between each of the plurality of passages and the user query, and
is configured to include a first score if the passage and the user query are relevant to each other or a second score if the passage and the user query are not relevant to each other.

15. The computerized method for generating answers of claim 13, wherein the ranker layer is trained to predict a relative similarity between passages included in the plurality of candidate documents using an inter-passage attention mechanism for the plurality of embedding vectors.

16. The computerized method for generating answers of claim 1, wherein the specifying of the relevant document further includes specifying a relevant passage associated with the user query among the passages included in the plurality of candidate documents to generate an answer to the user query.

17. The computerized method for generating answers of claim 16, wherein the preset criteria are used in the specifying of the relevant passage, wherein the passage that satisfies the preset criteria among the passages included in the plurality of candidate documents is specified as the relevant passage, and
the relevant passage corresponds to a passage included in the relevant document associated with the user query.

18. The computerized method for generating answers of claim 17, wherein in the generating of the answer,
the answer to the user query is generated using at least one of the relevant document and the relevant passage, and
information on the relevant document is displayed on the user terminal such that the relevant document used to generate the answer is confirmed by the user.

19. The computerized method for generating answers of claim 1, further comprising:
providing the answer generated for the user query to a service page,
wherein the service page further includes at least one recommended query associated with the relevant document.

20. An information retrieval system, comprising:
a memory configured to store executable instructions; and
one or more processors configured to perform an operation by executing one or more instructions,
wherein the information retrieval system receives a user query from a user terminal,
specifies a plurality of candidate documents associated with the user query based on presetcriteria,
determines relevance to the user query on a passage-by-passage basis for each passage included in at least one of the plurality of candidate documents,
specifies a relevant document associated with the user query among the plurality of candidate documents based on the relevance to the user query determined for each passage included in the plurality of candidate documents, and
generates an answer to the user query using the relevant document, wherein the answer is provided to the user terminal.
